(19) United States
(12) Patent Application Publication
(10) Pub. No.: US 2013/0113701 A1
(43) Pub. Date: May 9, 2013

(54) IMAGE GENERATION DEVICE

(71) Applicants: Taiji Sasaki, Osaka (JP); Hiroshi Yahata, Osaka (JP); Tomoki Ogawa, Osaka (JP)

(72) Inventors: Taiji Sasaki, Osaka (JP); Hiroshi Yahata, Osaka (JP); Tomoki Ogawa, Osaka (JP)

(21) Appl. No.: 13/807,509

(22) PCT Filed: Apr. 27, 2012
(86) PCT No.: PCT/JP2012/002905

§ 371 Date: Dec. 28, 2012

Related U.S. Application Data
(60) Provisional application No. 61/479,944, filed on Apr. 28, 2011.

(51) Int. Cl. G06T 15/00

(52) U.S. Cl. 345/156

(57) ABSTRACT

An image generation device 100 includes: a detection unit 210 that detects a viewer's viewpoint; a viewpoint calculation unit 220 that obtains a virtual viewpoint by multiplying the displacement of the viewer's viewpoint from a reference point by r (where r is a real number greater than 1); a generation unit 230 that generates an image seen from the virtual viewpoint; and an output unit 240 that outputs the generated image to an external display.

### TECHNICAL FIELD

The present invention relates to an image generation device for generating images representing a 3D object.

### BACKGROUND ART

There are well-known conventional technologies of generating an image representing a 3D object seen from a specified viewpoint. The technologies include, for example, a 3D computer graphics processing technology using Application Programming Interface (API) such as OpenGL, and a free viewpoint image generation technology using a multiple viewpoint image (See Patent Document 1 for example).

Besides, free-viewpoint televisions are well known. Free-viewpoint televisions detect the viewpoint of a viewer looking at a display screen on which a 3D object is displayed, and generate an image representing a 3D object seen from the detected viewpoint and display the image on the display screen.

With a conventional free-viewpoint television, when the viewer moves with reference to the display screen, the viewer can see an image representing the 3D object that should be seen from the viewpoint after the move.

### CITATION LIST

### Patent Literature

[Patent Literature 1] Japanese Patent Application Publication No. 2008-21210

### SUMMARY OF INVENTION

### Technical Problem

With a conventional free-viewpoint television, however, when the viewer wishes to see the object represented by an image from another angle that differs greatly from the current view angle, the viewer needs a relatively large move.

The present invention is made in view of such a problem, and aims to provide an image generation device with which a viewer needs a smaller move than conventional devices when the viewer wishes to see an object represented as an image from a different angle.

### Solution to Problem

To solve the problem, one aspect of the present invention is an image generation device for outputting images representing a 3D object to an external display device, comprising: a detection unit configured to detect a viewpoint of a viewer looking at an image displayed by the display device; a viewpoint calculation unit configured to obtain a virtual viewpoint by multiplying a displacement of the viewer's viewpoint from a reference point by r, the reference point being located in front of a screen area of the display device and r being a real number greater than 1; a generation unit configured to acquire data for generating images representing a 3D object, and generate an image representing the 3D object seen from the virtual viewpoint by using the data; and an output unit configured to output the image generated by the generation unit to the display device.

### Advantageous Effects of Invention

With an image generation device pertaining to an embodiment of the present invention having the stated structure, when the viewer looking at an image moves, the displacement of the virtual viewpoint, which will be the viewpoint of the image to be generated, is r times the displacement of the viewer's viewpoint (r is a real number greater than 1). With such an image generation device, when a viewer wishes to see the object from a different angle, the viewer needs a smaller move than with a conventional device.

### BRIEF DESCRIPTION OF DRAWINGS

FIG. 1 shows a structure of an image generation device 100.

FIG. 2 is a functional block diagram showing primary functional blocks constituting the image generation device 100.

FIG. 3 shows a relationship between a coordinate system for a real space and a coordinate system for a virtual space.

FIG. 4 is a schematic diagram showing a relationship between a screen surface 310 and a reference point 430.

FIG. 5A is a first schematic diagram illustrating shading, and FIG. 5B is a second schematic diagram illustrating shading.

FIG. 6 is a schematic diagram illustrating image generation using a perspective projection conversion method.

FIG. 7 is a schematic diagram showing a relationship between a right-eye original image and a left-eye original image.

FIG. 8 is a flowchart of image generation.

FIG. 9 is a schematic diagram illustrating an image generated by the image generation device 100.

FIG. 10A shows an image seen from a virtual viewer's viewpoint K940, and

FIG. 10B shows an image seen from a virtual viewpoint J950.

FIG. 11 is a functional block diagram showing primary functional blocks constituting an image generation device 1100.

FIG. 12 is a schematic diagram illustrating an image generated by the image generation device 1100.

FIG. 13 is a flowchart of a first modification of image generation.

FIG. 14A shows an image from a virtual viewer's viewpoint K940, and FIG. 14B shows an original image from a virtual viewpoint J950.

FIG. 15 is a functional block diagram showing primary functional blocks constituting an image generation device 1500.

FIG. 16 is a schematic diagram illustrating an image generated by the image generation device 1500.

FIG. 17A shows an image seen from a virtual viewer's viewpoint K940, and

FIG. 17B shows an original image seen from a virtual viewpoint J950.

FIG. 18 is a functional block diagram showing primary functional blocks constituting an image generation device 1800.

FIG. 19 is a schematic diagram showing a relationship between a screen surface 310 and a reference point 1930.

FIG. 20 is a schematic diagram illustrating an image generated by the image generation device 1800.

FIG. 21A shows an image seen from a virtual viewer's viewpoint K2040, and FIG. 21B shows an image seen from a virtual viewpoint J2050.

FIG. 22 is a first schematic diagram illustrating an example of sensing.

FIG. 23 is a second schematic diagram illustrating an example of sensing.

FIG. 24 is a first schematic diagram illustrating an example of head tracking.

FIG. 25 is a second schematic diagram illustrating an example of head tracking.

FIG. 26 is a first schematic diagram illustrating an example of light source positioning.

FIG. 27 is a second schematic diagram illustrating an example of light source positioning.

FIG. 28 is a schematic diagram showing a relationship between a viewer and an object.

FIG. 29 is a schematic diagram illustrating an example case when a lateral screen is provided.

FIG. 30 is a schematic diagram illustrating an example case of an ellipsoidal display screen.

FIG. 31 is a schematic diagram illustrating a “1 plane+offset” method.

FIG. 32 is a schematic diagram illustrating an example case using the “1 plane+offset” method.

FIG. 33 is a schematic diagram illustrating an actual-size scaling coefficient.

FIG. 34 is a schematic diagram showing an image generation device with a rotatable display.

FIG. 35 is a schematic diagram illustrating an example application of the image generation device 100.

FIG. 36 is a first schematic diagram showing a user virtually going inside the screen.

FIG. 37 is a second schematic diagram showing a method by which a user virtually goes inside the screen.

FIG. 38 is a first schematic diagram illustrating a system for achieving better communications between a hard-of-hearing person and an able-bodied person.

FIG. 39 is a second schematic diagram illustrating a system for achieving better communications between a hard-of-hearing person and an able-bodied person.

FIG. 40 is a block diagram showing a structure of an image generation device 4000.

### DESCRIPTION OF EMBODIMENTS

<Background leading to Embodiment of the Present Invention>

Conventional free-viewpoint televisions allow a viewer looking at an object displayed on a screen to feel like seeing the real object having a 3D structure.

However, the inventors of the present invention found that when the viewer wishes to see the object represented by an image from another angle that differs greatly from the current view angle, the viewer needs a relatively large move, and this could be a bother for the viewer.

The inventors assumed that it would be possible to reduce the bother for a viewer by developing an image generation device with which a viewer needs a smaller move than conventional devices when the viewer wishes to see an object represented as an image from a different angle.

To realize this idea, the inventors conceived of an image generation device that, when detecting the viewer's viewpoint, generates an image seen from a virtual viewpoint obtained by multiplying the displacement of the viewer's viewpoint from a predetermined reference point by r (where r is a real number greater than 1).

### Embodiment 1

<Overview>

The following describes an image generation device 100 as an embodiment of an image generation device pertaining to one aspect of the present invention, which generates a three-dimensional computer graphics (3DCG) image of a 3D object existing in a virtual space, and outputs the image to an external display.

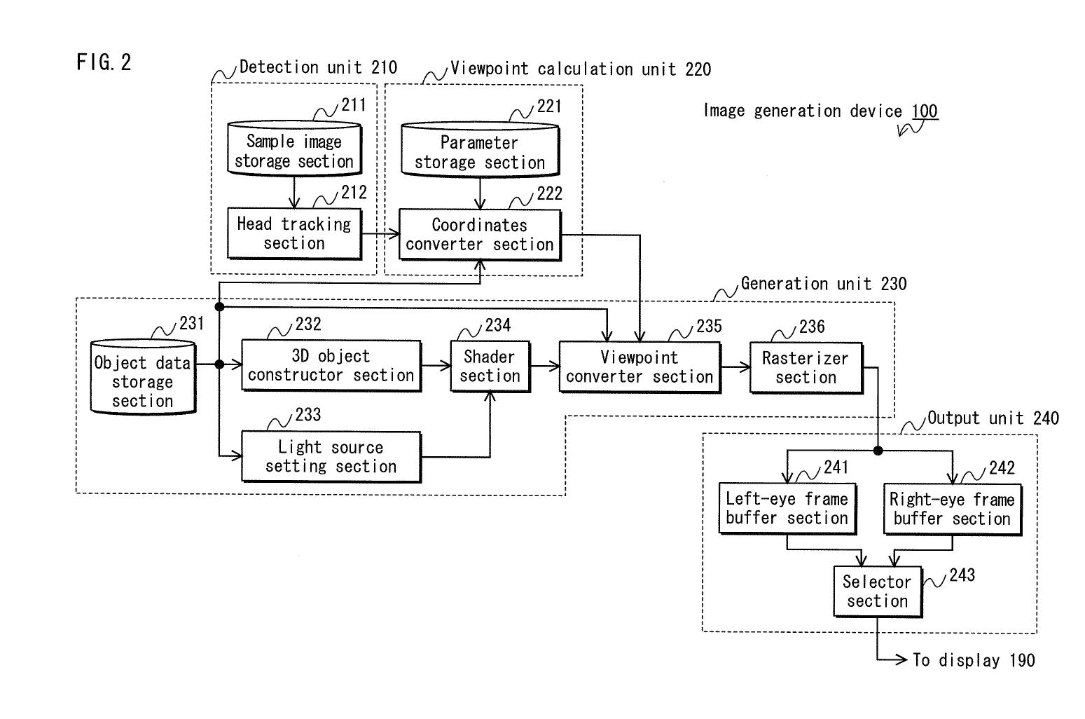

FIG. 2 is a functional block diagram showing primary functional blocks constituting the image generation device 100.

As shown in FIG. 2, the image generation device 100 includes: a detection unit 210 that detects the viewer's viewpoint; a viewpoint calculation unit 220 that obtains a viewpoint by multiplying the displacement of the viewer's viewpoint from a reference point by r (where r is a real number greater than 1); a generation unit 230 that generates a 3DCG image from the viewpoint; and an output unit 240 that outputs the generated image to an external display.

First, the hardware structure of the image generation device 100 is described with reference to the drawings.

<Hardware Structure>

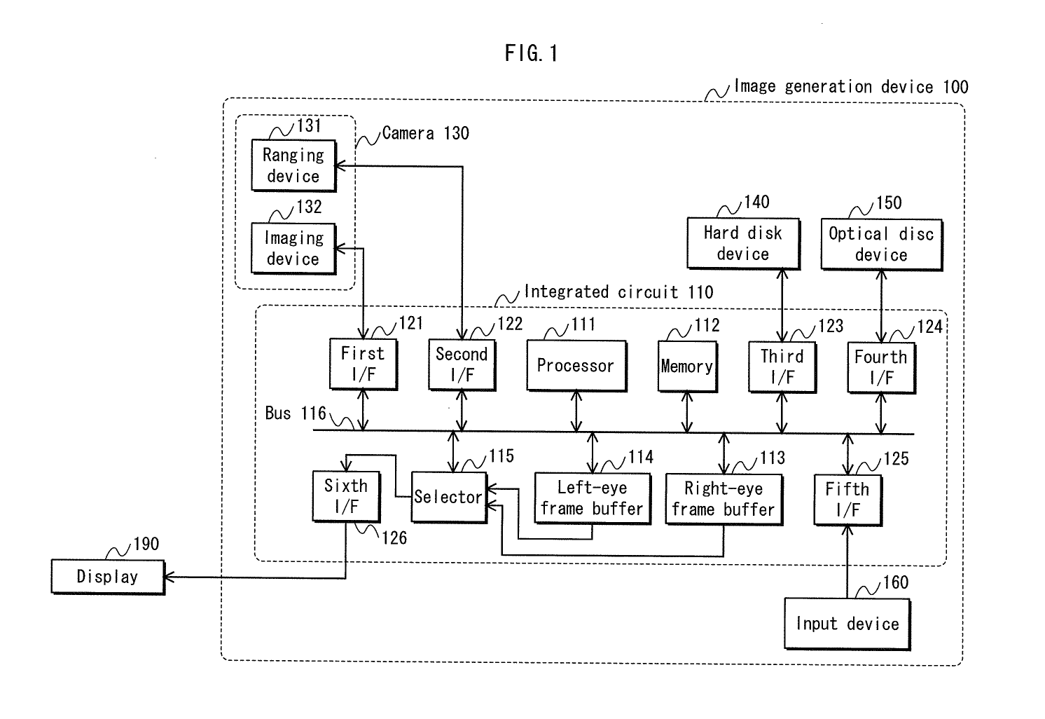

FIG. 1 shows the structure of the image generation device 100.

As shown in FIG. 1, the image generation device 100 includes: an integrated circuit 110; a camera 130; a hard disk device 140; an optical disc device 150; and an input device 160, and is connected to an external display 190.

The integrated circuit is a large scale integration (LSI) circuit into which the following are integrated: a processor 111; a memory 112; a right-eye frame buffer 113; a left-eye frame buffer 114; a selector 115; a bus 116; a first interface 121; a second interface 122; a third interface 123; a fourth interface 124; a fifth interface 125; and a sixth interface. The integrated circuit 110 is connected to the camera 130, the hard disk device 140, the optical disc device 150, the input device 160 and the display 190.

The memory 112 is connected to the bus 116, and includes a random access memory (RAM) and a read only memory (ROM). The memory 112 stores therein a program defining the operations of the processor 111. Part of the storage area of the memory 112 is used by the processor 111 as a main storage area.

The right-eye frame buffer 113 is a RAM connected to the bus 116 and the selector 115 and used for storing right-eye images (described later).

The left-eye frame buffer 114 is a RAM connected to the bus 116 and the selector 115 and used for storing left-eye images (described later).

The selector 115 is connected to the bus 116, the processor 111, the right-eye frame buffer 113, the left-eye frame buffer 114 and the sixth interface 126. The selector 115 is under the control of processor 111, and has the function of alternately selecting a right-eye image stored in the right-eye frame buffer 113 or a left-eye image stored in the left-eye frame buffer 114 and outputting the selected image to the sixth interface 126 with predetermined intervals (e.g. every 1/120 sec).

The bus 116 is connected to the processor 111, the memory 112, the right-eye frame buffer 113, the left-eye frame buffer 114, the selector 115, the first interface 121, the second interface 122, the third interface 123, the fourth interface 124, and the fifth interface 125, and has the function of transmitting signals between the connected circuits.

Each of the first interface 121, the second interface 122, the third interface 123, the fourth interface 124 and the fifth interface 125 is connected to the bus 116, and each has the following functions: the function of transmitting signals between an imaging device 132 (described later) and the bus 116; the function of transmitting signals between a ranging device 131 and the bus 116; the function of transmitting signals between the bus 116 and the hard disk device 140; the function of transmitting signals between the bus 116 and the optical disc device 150; and the function of transmitting signals between the input device 160 and the bus 116. The sixth interface 126 is connected to the selector 115, and has the function of transmitting signals between the selector 115 and the external display 190.

The processor 111 is connected to the bus 116, and executes the program stored in the memory 112 to realize the function of controlling the selector 115, the ranging device 131, the imaging device 132, the hard disk device 140, the optical disc device 150 and the input device 160. The processor 111 also has the function of causing the image generation device 100 to perform image generation by executing the program stored in the memory 112 and thereby controls the devices. Note that the image generation mentioned above will be described in detail in the section “Image Generation” below with reference to a flowchart.

The camera 130 includes the ranging device 131 and the imaging device 132. The camera 130 is mounted on a top part of the screen surface of the display 190, and has the function of photographing the subject near the screen surface of the display 190.

The imaging device 132 is connected to the first interface 121, and is under the control of processor 111. The imaging device 132 includes a solid-state imaging device (e.g. complementary metal oxide semiconductor (CMOS) imaging sensor) and a set of lenses for condensing external light toward the solid state imaging device, and has the function of photographing an external subject at a predetermined frame rate (e.g. 30 fps) and generating and outputting images composed of a predetermined number (e.g. 640×480) of pixels.

The ranging device 131 is connected to the second interface 122, and is under the control of the processor 111. The ranging device 131 has the function of measuring the distance to the subject in units of pixels. The ranging device 131 measures the distance by using, for example, a time of flight (TOF) method, by which the distance is obtained by irradiating the subject with a laser beam such as an infrared ray and measuring the time the beam takes to come back after being reflected off the subject.

The hard disk device 140 is connected to the third interface 123, and is under the control of the processor 111. The hard disk device 140 has a built-in hard disk, and has the function of wiring data into the built-in hard disk and reading data from the built-in hard disk.

The optical disc device 150 is connected to the fourth interface 124, and is under the control of the processor 111. The optical disc device 150 is a device to which an optical disc (such as a Blu-ray™ disc) is detachably attached, and has the function of reading data from the attached optical disc.

The input device 160 is connected to the fifth interface 125, and is under the control of the processor 111. The input device 160 has the function of receiving an instruction from the user, converting the instruction to an electronic signal, and sending the signal to the processor 111. The input device 160 is realized with, for example, a keyboard and a mouse.

The display 190 is connected to the sixth interface 126, and has the function of displaying an image according to the signal received from the image generation device 100. The display 190 is, for example, a liquid crystal display having a rectangular screen whose horizontal sides are 890 mm long and vertical sides are 500 mm long.

The following describes the components of the image generation device 100 with the above-described hardware structure in terms of their respective functions, with reference to the drawings.

<Functional Structure>

As shown in FIG. 2, the image generation device 100 includes the detection unit 210, the viewpoint calculation unit 220, the generation unit 230 and the output unit 240.

The detection unit 210 is connected to the viewpoint calculation unit 220, and includes a sample image storage section 211 and a head tracking section 212. The detection unit 210 has the function of detecting the viewpoint of the viewer looking at the screen of the display 190.

The head tracking section 212 is connected to the sample image storage section 211 and a coordinates converter section 222 (described later), and is realized by the processor 111 executing a program and thereby controlling the ranging device 131 and the imaging device 132. The head tracking section 212 has the following four functions.

Photographing function: the function of photographing the subject located near the screen surface of the display 190, and generating an image composed of a predetermined number (e.g. 640×480) of pixels.

Ranging function: the function of measuring the distance to the subject located near the screen surface of the display 190 at a predetermined frame rate (e.g. 30 fps).

Face detecting function: the function of detecting a facial area in the photographed subject by performing matching using sample images stored in the sample image storage section 211.

Eye position calculating function: the function, when the facial area is detected, of detecting the position of the right eye and the position of the left eye by further performing matching using sample images stored in the sample image storage section 211, and calculating the coordinates of the right eye and the coordinates of the left eye in the real space. In the following, the position of the right eye and the position of the left eye may be collectively referred to as the eye position, without making distinction between them.

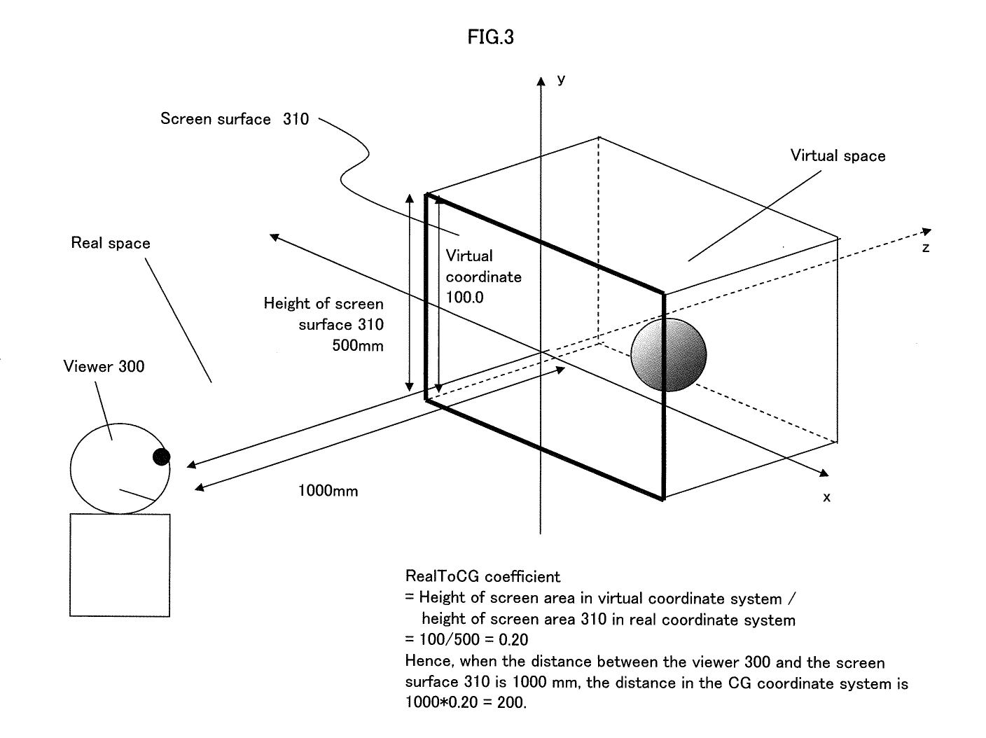

FIG. 3 shows a relationship between a coordinate system for the real space (hereinafter referred to as “real coordinate system”) and a coordinate system for a virtual space (hereinafter referred to as “virtual coordinate system”).

The real coordinate system is a coordinate system for the real world in which the display 190 is located. The virtual coordinate system is a coordinate system for a virtual space that is constructed in order that the image generation device 100 can generate a 3DCG image.

As shown in the figure, both the real coordinate system and the virtual coordinate system have the origin at the center point of the screen surface 310 of the display 190, and their X axes, Y axes and Z axes respectively indicate the horizontal direction, the vertical direction, and the depth direction. From the viewpoint of the viewer 300 looking at the screen surface 310, the rightward direction corresponds to the positive direction along the X axes, the upward direction corresponds to the positive direction along the Y axes, and the direction from the screen surface 310 toward the viewer corresponds to the positive direction along the Z axes.

Real coordinates in the real coordinate system can be converted to virtual coordinates in the virtual coordinate system by multiplying the real coordinates by a RealToCG coefficient as a coordinates conversion coefficient.

For example, as shown in FIG. 3, when the height of the screen surface 310 in the real space is 500 mm and the height of the screen area in the virtual space is 100.0, the RealToCG coefficient is 100.0/500=0.20.

Returning to FIG. 2, the following further explains the functional structure of the image generation device 100.

The sample image storage section 211 is connected to the head tracking section 212, and is realized as a part of the storage area of the memory 112. The sample image storage section 211 has the function of storing the sample images used in matching performed by the head tracking section 212 to detect the facial area, and the sample images used in matching performed by the head tracking section 212 to calculate the coordinates of the right eye and the coordinates of the right eye.

The viewpoint calculation unit 220 is connected to the detection unit 210 and the generation unit 230, and includes a parameter storage section 221 and a coordinates converter section 222. The viewpoint calculation unit 220 has the function of obtaining a viewpoint by multiplying the displacement of the viewer's viewpoint from the reference point by r.

The coordinates converter section 222 is connected to the head tracking section 212, the parameter storage section 221, a viewpoint converter section 235 (described later) and an object data storage section 231 (described later), and is realized by the processor 111 executing a program. The coordinates converter section 222 has the following three functions.

Reference point determination function: the function of obtaining, for each of the right eye and the left eye whose positions are detected by the head tracking section 212, a reference plane that is in parallel with the screen surface of the display 190 and includes the position of the eye, and determining, as the reference point, a point that is in the reference plane and is opposite the center point in the screen surface of the display 190. Here, the point that is in the reference plane and is opposite the center point in the screen surface is the point that is closer to the center point in the screen surface than any points on the reference plane.

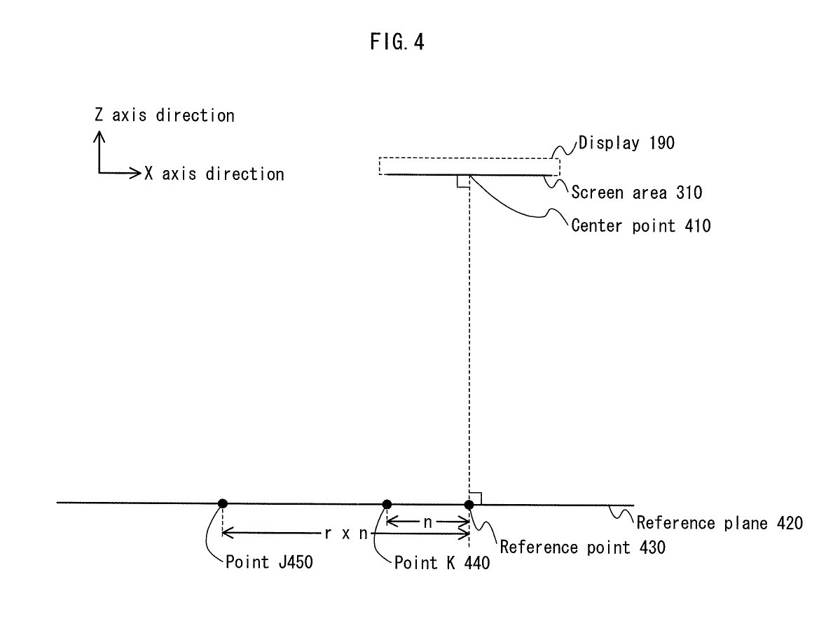

FIG. 4 is a schematic diagram showing a relationship between the screen surface 310 of the display 190 and the reference point 430 when the display 190 is seen from the positive side of the Y axis (see FIG. 3). In this example, the screen surface 310 is perpendicular to the Z axis.

In the drawing, the point K440 is the viewer's viewpoint detected by the head tracking section 212. The point J450 will be discussed later.

The reference plane 420 is a plane that contains the point K440 and is parallel to the screen surface 310.

The reference point 430 is the point that is closer to the screen surface center 410 than any points on the reference plane 420.

The following further explains the function of the coordinates converter section 222.

Viewpoint calculating function: the function of obtaining the right-eye viewpoint and the left-eye viewpoint by, for each of the right-eye position and the left-eye position detected by the head tracking section 212, multiplying the displacement from the corresponding reference point in the corresponding reference plane by r. Here, obtaining the viewpoint by “multiplying the displacement in the reference plane by r” means defining a vector lying on the reference plane and having the start point at the reference point and the end point at the eye position, multiplying the magnitude of the vector by r while keeping the direction of the vector, and obtaining the end point of the vector after the multiplication as the viewpoint. The value of r may be freely set by the user of the image generation device 100 by using the input device 160. In the following, the right-eye viewpoint and the left-eye viewpoint may be collectively referred to as the viewpoint, without making distinction between them.

In FIG. 4, the point J450 is the viewpoint obtained by the coordinates converter section 222 when the eye position detected by the head tracking section 212 is at the point K440.

The point J450 is obtained by multiplying the displacement from the reference point 430 to the point K440 in the reference plane 420 by r.

The following further explains the function of the coordinates converter section 222.

Coordinates converting function: the function of converting the coordinates indicating the right-eye viewpoint (hereinafter called “right-eye viewpoint coordinates”) and the coordinates indicating the left-eye viewpoint (hereinafter called “left-eye viewpoint coordinates”) to virtual right-eye viewpoint coordinates and left-eye viewpoint coordinates.

The RealToCG coefficient, which is the coefficient used for converting real coordinates to virtual coordinates, is calculated by reading the height of the screen area from the object data storage section 231 (described later), reading the height of the screen surface 310 from the parameter storage section 221 (described later), and dividing the height of the screen area by the height of the screen surface 310.

For example, as shown in FIG. 3, when the height of the screen surface 310 in the real space is 500 mm, the height of the screen area in the virtual space is 100.0, and the viewer 300 is 1000 mmm away from the center of the screen surface 310 in the Z axis direction, the Z coordinate of the viewer 300 in the virtual coordinate system is 1000×(100.0/500)=200.

Note that a point in the virtual space represented by virtual right-eye viewpoint coordinates is referred to as a virtual right-eye viewpoint, and a point in the virtual space represented by virtual left-eye viewpoint coordinates is referred to as a virtual left-eye viewpoint. In the following, the virtual right-eye viewpoint and the virtual left-eye viewpoint may be collectively referred to as the virtual viewpoint, without making distinction between them.

Returning to FIG. 2, the following further explains the functional structure of the image generation device 100.

The parameter storage section 221 is connected to the coordinates converter section 222, and is realized as a part of the storage area of the memory 112. The parameter storage section 221 has the function of storing information used by the coordinates converter section 222 for calculating coordinates in the real space and information indicating the size of the screen surface 310 in the real space.

The generation unit 230 is connected to the viewpoint calculation unit 220 and the output unit 240, and includes an object data storage section 231, a 3D object constructor section 232, a light source setting section 233, a shader section 234, a viewpoint converter section 235, and a rasterizer section 236. The generation unit 230 has the function of realizing processing for generating 3DCG images that can be seen from the viewpoints. This processing is called graphics pipeline processing.

The object data storage section 231 is connected to the 3D object constructor section 232, the light source setting section 233, the viewpoint converter section 235 and the coordinates converter section 222, and is realized with the storage area in the built-in hard disk of the hard disk device 140 and the storage area of the optical disc mounted on the optical disc device 150. The object data storage section 231 has the function of storing information relating to the position and the shape of a virtual 3D object in the virtual space, information relating the position and the characteristics of a virtual light source in the virtual space, and information relating to the position and the shape of the screen area.

The 3D object constructor section 232 is connected to the object data storage section 231 and the shader section 234, and is realized by the processor 111 executing a program. The 3D object constructor section 232 has the function of reading from the object data storage section 231 the information relating to the position and the shape of the virtual object existing in the virtual space, and rendering the object within the virtual space. The rendering of the object within the virtual space is realized by, for example, rotating, moving, scaling up, or scaling down the object by processing the information representing the shape of the object.

The light source setting section 233 is connected to the object data storage section 231 and the shader section 234, and is realized by the processor 111 executing a program. The light source setting section 233 has the function of reading from the object data storage section 231 the information relating to the position and the characteristics of a virtual light source, and setting the light source within the virtual space.

The shader section 234 is connected to the 3D object constructor section 232, the light source setting section 233 and the viewpoint converter section 235, and is realized by the processor 111 executing a program. The shader section 234 has the function of adding shading to each object rendered by the 3D object constructor section 232, according to the light source set by the light source setting section 233.

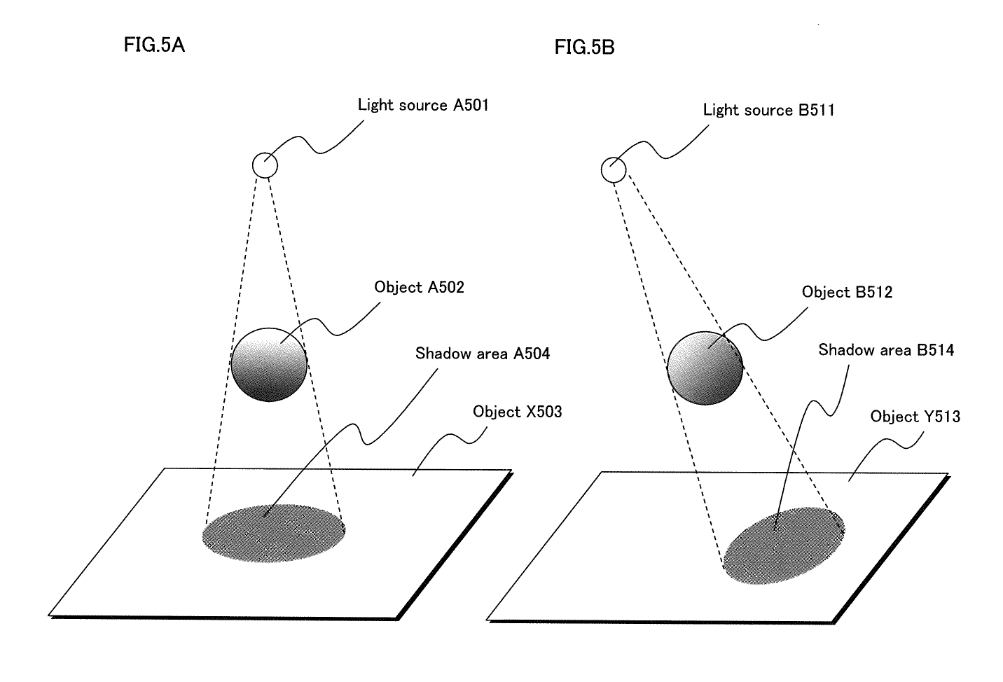

FIGS. 5A and 5B are schematic diagrams illustrating the shading performed by the shader section 234.

FIG. 5A is a schematic diagram showing an example case where a light source A501 is located above a spherical object A502. In this case, the shader section 234 adds shading to the object A502 such that the upper part of the object A502 appears to reflect a large amount of light and the lower part of the object A502 appears to reflect a small amount of light. Then, the shader section 234 locates the area on the object X503 where a shadow should be cast by the object A502, and adds shading to the area.

FIG. 5B is a schematic diagram showing an example case where a light source B511 is located above left of a spherical object B512. In this case, the shader section 234 adds shading to the object B512 such that the upper left part of the object B512 appears to reflect a large amount of light and the lower right part of the object B512 appears to reflect a small amount of light. Then, the shader section 234 locates the area on the object Y513 where a shadow should be cast by the object B512, and adds shading to the area.

The viewpoint converter section 235 is connected to the coordinates converter section 222, the object data storage section 231 and the shader section 234, and is realized by the processor 111 executing a program. The viewpoint converter section 235 has the function of generating, as projection images of the object with shading given by the shader section 234, a projection image (hereinafter referred to as “right-eye original image”) on the screen area seen from the virtual right-eye viewpoint obtained by the coordinates converter section 222 and a projection image (hereinafter referred to as “left-eye original image”) on the screen area seen from the virtual left-eye viewpoint obtained by the coordinates converter section 222, by using a perspective projection conversion method. Here, the image generation using the perspective projection conversion method is performed by specifying a viewpoint, a front clipping area, a rear clipping area, and a screen area.

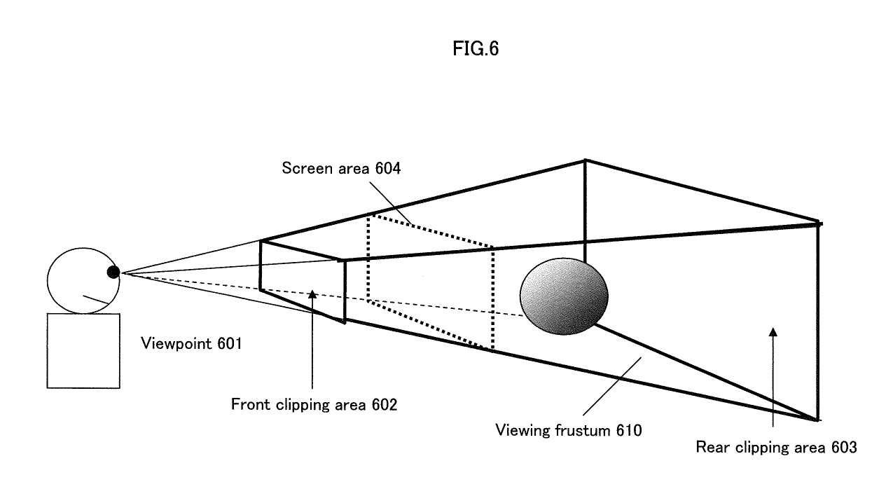

FIG. 6 is a schematic diagram illustrating image generation by the viewpoint converter section 235 using a perspective projection conversion method.

In the drawing, the viewing frustum 610 is a space defined by line segments (bold lines in FIG. 6) connecting the vertices of the specified front clipping area 602 and the specified rear clipping area 603.

According to this image generation using the perspective projection conversion method, a perspective 2D projection image of the object contained in the viewing frustum 610 from the specified viewpoint 601 is generated on the screen area 604. According to this perspective projection conversion method, the vertices of the screen area are located on the straight lines connecting the vertices of the front clipping area and the vertices of the rear clipping area. Therefore, by this method, it is possible to generate an image that makes the viewer, who is looking at the screen surface of the display that shows the image, feel as if he/she is looking into the space in which the object exists through the screen surface.

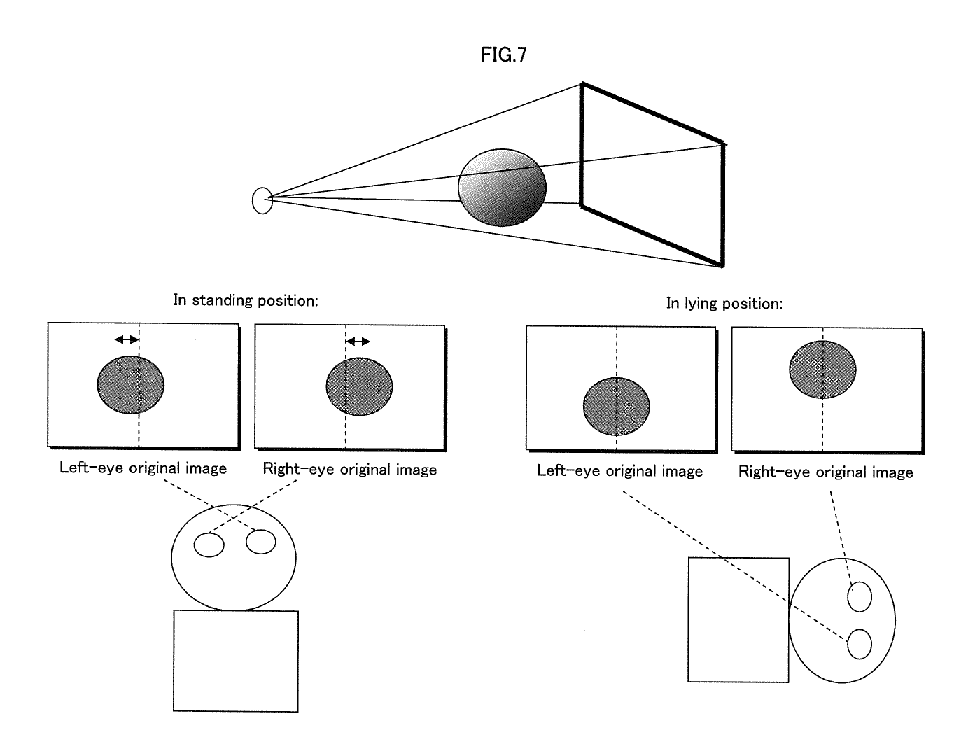

FIG. 7 is a schematic diagram showing a relationship between the right-eye original image and the left-eye original image generated by the viewpoint converter section 235.

As shown in the drawing, when the viewer looks at the screen surface 310 of the display 190 in a standing position, the right eye and the left eye of the viewer have different coordinates with respect to the X axis direction (see FIG. 3), and therefore the right-eye original image and the left-eye original image cause binocular disparity in the X axis direction. When the viewer looks at the screen surface 310 of the display 190 in a lying position, the right eye and the left eye of the viewer have different coordinates with respect to the Y axis direction (see FIG. 3), and therefore the right-eye original image and the left-eye original image cause binocular disparity in the Y axis direction. In this way, the viewpoint converter section 235 generates the right-eye original image and the left-eye original image so as to cause disparity in an appropriate direction according to the viewer's posture.

Returning to FIG. 2, the following further explains the functional structure of the image generation device 100.

The rasterizer section 236 is connected to the viewpoint converter section 235, a left-eye frame buffer section 241 (described later), and a right-eye frame buffer section 242 (described later), and is realized by the processor 111 executing a program. The rasterizer section 236 has the following two functions.

Texture applying function: the function of applying texture to the right-eye original image and the left-eye original image generated by the viewpoint converter section 235.

Rasterizing function: the function of generating a right-eye raster image and a left-eye raster image respectively from the right-eye original image and the left-eye original image to which the texture has been applied. The raster images are, for example, bitmap images. Through the rasterizing, the pixel values of the pixels constituting the image to be generated are determined.

The output unit 240 is connected to the generation unit 230, and includes the right-eye frame buffer 242, the left-eye frame buffer section 241, and a selector section 243. The output unit 240 has the function of outputting the images generated by the generation unit 230 to the display 190.

The right-eye frame buffer section 242 is connected to the rasterizer section 236 and the selector section 243, and is realized with the processor 111 executing a program and the right-eye frame buffer 113. The right-eye frame buffer section 242 has the function of storing the right-eye images generated by the rasterizer section 236 into the right-eye frame buffer 113 included in the right-eye frame buffer section 242.

The left-eye frame buffer section 241 is connected to the rasterizer section 236 and the selector section 243, and is realized with the processor 111 executing a program and the left-eye frame buffer 114. The left-eye frame buffer section 242 has the function of storing the left-eye images generated by the rasterizer section 236 into the left-eye frame buffer 114 included in the left-eye frame buffer section 242.

The selector section 243 is connected to the right-eye frame buffer section 242 and the left-eye frame buffer section 241, and is realized with the processor 111 executing a program and controlling the selector 115. The selector section 243 has the function of alternately selecting the right-eye images stored in the right-eye frame buffer section 242 and the left-eye images stored in the left-eye frame buffer section 241 with predetermined intervals (e.g. every 1/120 seconds), and outputting the images to the display 190. Note that the viewer looking at the display 190 can see a stereoscopic image having a depth by wearing an active shutter glasses that operate in synchronization with the selector section 243 according to the predetermined intervals.

The following describes the operations of the image generation device 100 having the stated structure, with reference to the drawings.

<Operations>

The following explains the operation for image generation, which is particularly characteristic among the operations performed by the image generation device 100.

<Image Generation>

The image generation is processing by which the image generation device 100 generates an image to be displayed on the screen surface 310 of the display 190 according to the viewpoint of the viewer looking at the screen surface 310.

In the image generation, the image generation device 100 repeatedly generates right-eye images and left-eye images according to the frame rate of photographing performed by the head tracking section 212.

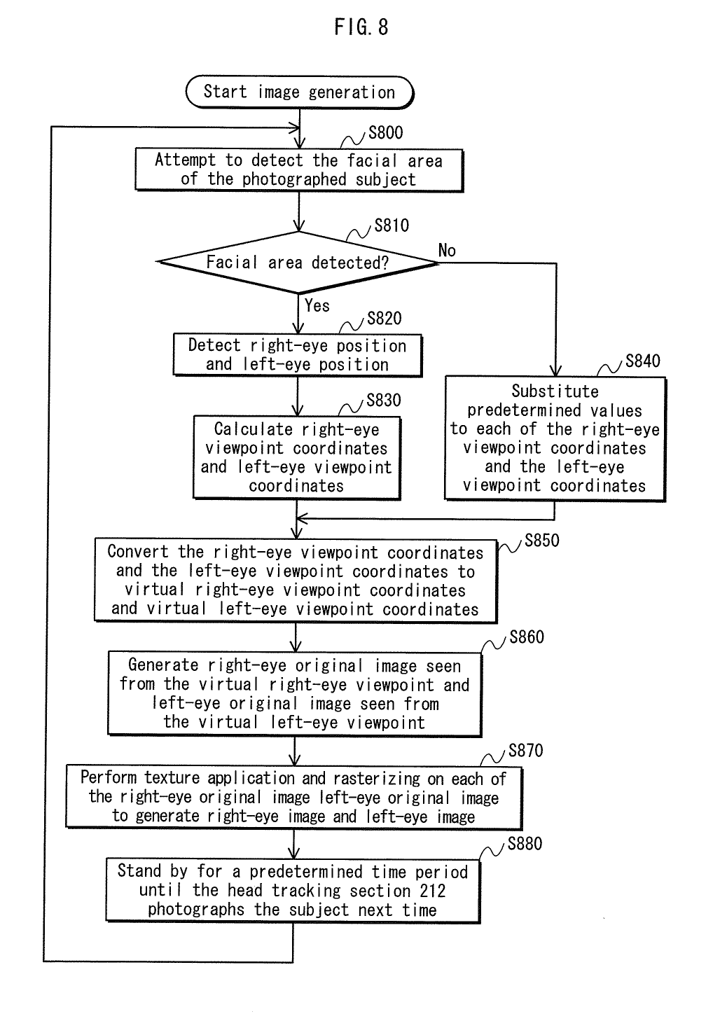

FIG. 8 is a flowchart of the image generation.

The image generation is triggered by a command input to the image generation device 100 by a user of the image generation device 100, which instructs the image generation device 100 to start the image generation. The user inputs the command by operating the input device 160.

Upon commencement of the image generation, the head tracking section 212 photographs the subject near the screen surface 310 of the display 190, and attempts to detect the facial area of the photographed subject (Step S800). If successfully detecting the facial area (Step S810: Yes), the head tracking section 212 detects the right-eye position and the left-eye position (Step S820), and calculates the coordinates of the right-eye position and the coordinates of the left-eye position.

After the calculation of the right-eye coordinates and the left-eye coordinates, the coordinates converter section 222 calculates the right-eye viewpoint coordinates and the left-eye viewpoint coordinates from the right-eye coordinates and the left-eye coordinates (Step S830).

If the head tracking section 212 fails to detect the facial area in Step S810 (Step S810: NO), the coordinates converter section 222 substitutes predetermined values to each of the right-eye viewpoint coordinates and the left-eye viewpoint coordinates, respectively (Step S840).

Upon completion of Step S830 or Step S840, the coordinates converter section 222 converts the right-eye viewpoint coordinates and the left-eye viewpoint coordinates to the virtual right-eye viewpoint coordinates and the virtual left-eye viewpoint coordinates, respectively (Step S850).

Upon conversion of the right-eye viewpoint coordinates and the left-eye viewpoint coordinates to the virtual right-eye viewpoint coordinates and the virtual left-eye viewpoint coordinates, the viewpoint converter section 235 generates the right-eye original image seen from the virtual right-eye viewpoint and the left-eye original image seen from the virtual left-eye viewpoint (Step S860).

Upon generation of the right-eye original image and the left-eye original image, the rasterizer section 236 performs texture application and rasterizing on each of the right-eye original image left-eye original image to generate the right-eye image and the left-eye image. The right-eye image and the left-eye image so generated are stored into the right-eye frame buffer section 242 and the left-eye frame buffer section 241, respectively (Step S870).

When the right-eye image and the left-eye image are stored, the image generation device 100 stands by for a predetermined time period until the head tracking section 212 photographs the subject next time, and then repeats the steps from Step S800 (S880).

<Consideration>

The following describes how the images, generated by the image generation device 100 having the stated structure, are perceived by the viewer.

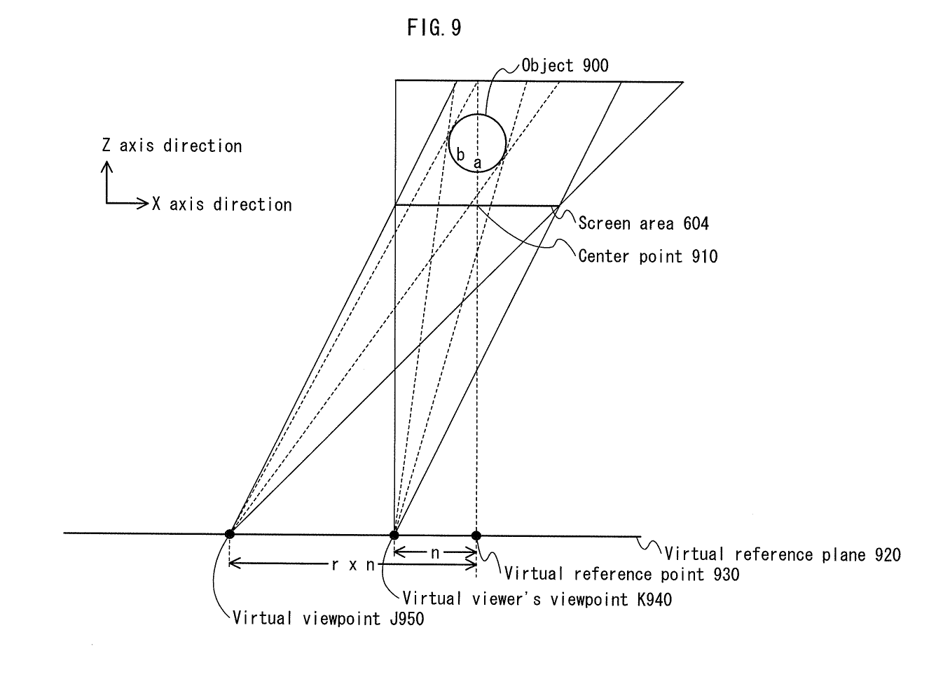

FIG. 9 is a schematic diagram illustrating an image generated by the image generation device 100, and shows the positional relationship among the object, the screen area and the virtual viewpoint in the virtual space.

In the drawing, the screen area 604 is perpendicular to the Z axis, and the drawing shows the screen area 604 seen in the positive to negative direction of the Y axis (see FIG. 3) in the virtual space.

The virtual viewer's viewpoint K940 indicates the position in the virtual space that corresponds to the point K440 in FIG. 4. That is, the viewpoint indicates the position in the virtual space that corresponds to the viewer's viewpoint detected by the head tracking section 212.

The virtual viewpoint J950 is the position in the virtual space that corresponds to the point J450 in FIG. 4. That is, the virtual viewpoint J950 is the virtual viewpoint obtained by the coordinates converter section 222.

The virtual reference plane 920 is the position in the virtual space that corresponds to the reference plane 420 in FIG. 4.

The virtual reference point 930 is the position in the virtual space that corresponds to the reference point 430 in FIG. 4.

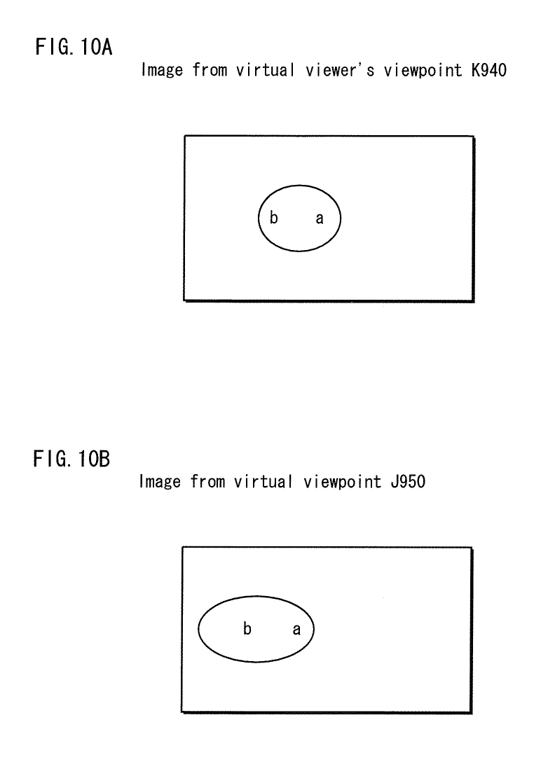

FIG. 10A shows an image containing an object 900 seen from the virtual viewer's viewpoint K940 in the case where the screen area 604 is determined as the screen area used in the perspective projection conversion method. FIG. 10B shows an image containing the object 900 seen from the virtual viewpoint J950 in the case where the screen area 604 is determined as the screen area used in the perspective projection conversion method.

As shown in FIG. 9, the displacement of the virtual viewpoint J950 from the virtual reference point 930 is r times the displacement of the virtual viewer's viewpoint K940 from the virtual reference point 930. Therefore, as shown in FIGS. 10A and 10B, the view of the object 900 from the virtual viewpoint J950 is more similar to the lateral view of the object 900 than the view of the object 900 from the virtual viewer's viewpoint K940.

As described above, the viewer looking at the display 190 from the viewpoint K440 shown in FIG. 4 can get a view of the image on the display 190 as if the viewer is looking at the display 190 from the viewpoint J450 obtained by multiplying the displacement from the reference point 430 by r.

Note that as shown in FIG. 9, the angle of view of the screen area 604 from the virtual viewpoint J950 is smaller than the angle of view of the screen area 604 from the virtual viewer's viewpoint K940.

### <Modification 1>

The following describes an image generation device 1100 as another embodiment of an image generation device pertaining to one aspect of the present invention. The image generation device 1100 is obtained by modifying part of the image generation device 100 pertaining to Embodiment 1.

<Overview>

The image generation device 1100 has the same hardware structure as the image generation device 100 pertaining to Embodiment 1, but executes a partially different program than the program executed by the image generation device 100 pertaining to Embodiment 1.

The structure of the image generation device 100 pertaining to Embodiment 1 is an example structure for, when detecting the viewpoint of the viewer looking at the screen surface 310 of the display 190, generating an image from a viewpoint obtained by multiplying the displacement from the reference point to the viewer's viewpoint by r. With this structure, the angle of view of the screen surface 310 from the viewer's viewpoint is smaller than the angle of view of the screen surface 310 from the viewer's viewpoint.

The structure of the image generation device 1100 pertaining to Modification 1 is also an example structure for, when detecting the viewpoint of the viewer, generating an image from a viewpoint obtained by multiplying the displacement from the reference point to the viewer's viewpoint by r. However, the image generation device 1100 pertaining to Modification 1 generates the image so that the angle of view will be the same as the angle of view of the screen surface 310 from the viewer's viewpoint.

The following describes the structure of the image generation device 1100 pertaining to Modification 1 with reference to the drawings, focusing on the differences from the image generation device 100 pertaining to Embodiment 1.

<Structure>

<Hardware Structure>

The image generation device 1100 has the same hardware structure as the image generation device 100 pertaining to Embodiment 1. Hence, the explanation thereof is omitted.

<Functional Structure>

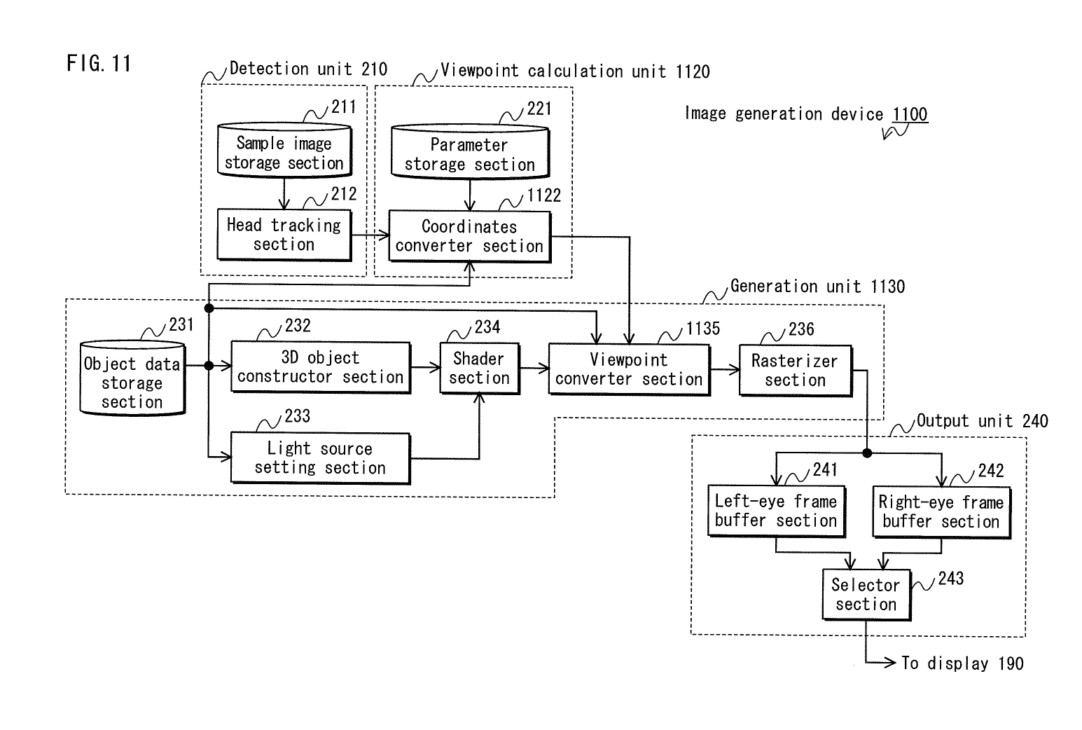

FIG. 11 is a functional block diagram showing primary functional blocks constituting the image generation device 1100.

As shown in the drawing, the image generation device 1100 includes a coordinates converter section 1122 and a viewpoint converter section 1135, which are modified from the coordinates converter section 222 and the viewpoint converter section 235 of the image generation device 100 pertaining to Embodiment 1, respectively. According to this modification, the viewpoint calculation unit 220 is modified to be a viewpoint calculation unit 1120, and the generation unit 230 is modified to be a generation unit 1130.

The coordinates converter section 1122 has the functions that are partially modified from the coordinates converter section 222 pertaining to Embodiment 1, and is connected to the head tracking section 212, the parameter storage section 221, the viewpoint converter section 1135 and the object data storage section 231. The coordinates converter section 1122 is realized by the processor 111 executing a program, and has an additional coordinates converting function described below, in addition to the reference point determination function, the viewpoint calculating function, the coordinates converting function of the coordinates converter section 222 pertaining to Embodiment 1.

Additional coordinates converting function: the function of converting the right-eye coordinates and the left-eye coordinates obtained by the head tracking section 212 to virtual right-eye viewer's viewpoint coordinates and virtual left-eye viewer's viewpoint coordinates.

The viewpoint converter section 1135 has the functions that are partially modified from the viewpoint converter section 235 pertaining to Embodiment 1, and is connected to the coordinates converter section 1122, the object data storage section 231, the shader section 234 and the rasterizer section 236. The viewpoint converter section 1135 is realized by the processor 111 executing a program, and has the following four functions:

View angle calculating function: the function of calculating the angle of view of the screen area from the virtual right-eye viewer's viewpoint represented by the virtual right-eye viewer's viewpoint coordinates calculated by the viewpoint converter section 1135 (hereinafter referred to as “right-eye viewer's viewpoint angle”), and the angle of view of the screen area from the virtual left-eye viewer's viewpoint represented by the virtual left-eye viewer's viewpoint coordinates calculated by the viewpoint converter section 1135 (hereinafter referred to as “left-eye viewer's viewpoint angle”). In the following, the right-eye viewer's viewpoint angle and the left-eye viewer's viewpoint angle may be collectively referred to as the viewer's viewpoint angle, without making distinction between them.

Enlarged screen area calculating function: the function of calculating an enlarged right-eye screen area, which is defined in the plane including the screen area and has the right-eye viewer's viewpoint angle with respect to the virtual right-eye viewpoint, and an enlarged left-eye screen area, which is defined in the plane including the screen area and has the left-eye viewer's viewpoint angle with respect to the virtual left-eye viewpoint. In this regard, the viewpoint converter section 1135 calculates the enlarged right-eye screen area so that the center point of the enlarged right-eye screen area coincides with the center point of the screen area, and calculates the enlarged left-eye screen area so that the center point of the enlarged left-eye screen area coincides with the center point of the screen area.

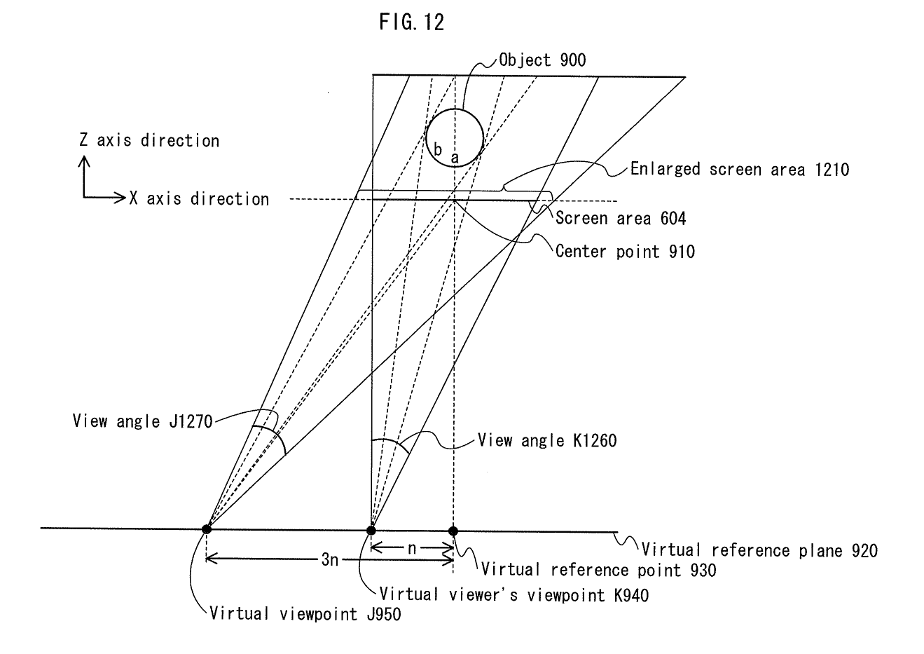

FIG. 12 is a schematic diagram showing a relationship among the object, the screen area, the enlarged screen area, the virtual viewer's viewpoint, and the virtual viewpoint.

In this drawing, the view angle K1260 is the angle of view of the screen area 604 with respect to the virtual viewer's viewpoint K940.

The view angle J1270 is equal to the view angle K1260.

The enlarged screen area 1210 is defined in the plane including the screen area 604 and has the view angle J1270 with respect to the virtual viewer's viewpoint J950. The center point of the enlarged screen area 1210 coincides with the screen area center 910.

The following further explains the function of the viewpoint converter section 1135.

Enlarged original image generating function: the function of generating, as projection images of the object with shading given by the shader section 234, a projection image (hereinafter referred to as “enlarged right-eye original image”) on the enlarged screen area seen from the virtual right-eye viewpoint obtained by the coordinates converter section 1122 and a projection image (hereinafter referred to as “enlarged left-eye original image”) on the screen area seen from the virtual left-eye viewpoint obtained by the coordinates converter section 222, by using a perspective projection conversion method. In the following, the enlarged right-eye original image and the enlarged left-eye original image may be collectively referred to as “the enlarged original image”, without making distinction between them.

Image scaling down function: The function of generating the right-eye original image by scaling down the enlarged right-eye original image so that the enlarged right-eye original image equals to the screen area in size, and the left-eye original image by scaling down the enlarged left-eye original image the enlarged left-eye original image equals to the screen area in size.

The following describes the operations of the image generation device 1100 having the stated structure, with reference to the drawings.

<Operations>

The following explains the operation for the first modification of the image generation, which is particularly characteristic among the operations performed by the image generation device 1100.

<First Modification of Image Generation>

The first modification of the image generation is processing by which the image generation device 1100 generates an image to be displayed on the screen surface 310 of the display 190 according to the viewpoint of the viewer looking at the screen surface 310, which is partially modified from the image generation pertaining to Embodiment 1 (See FIG. 8).

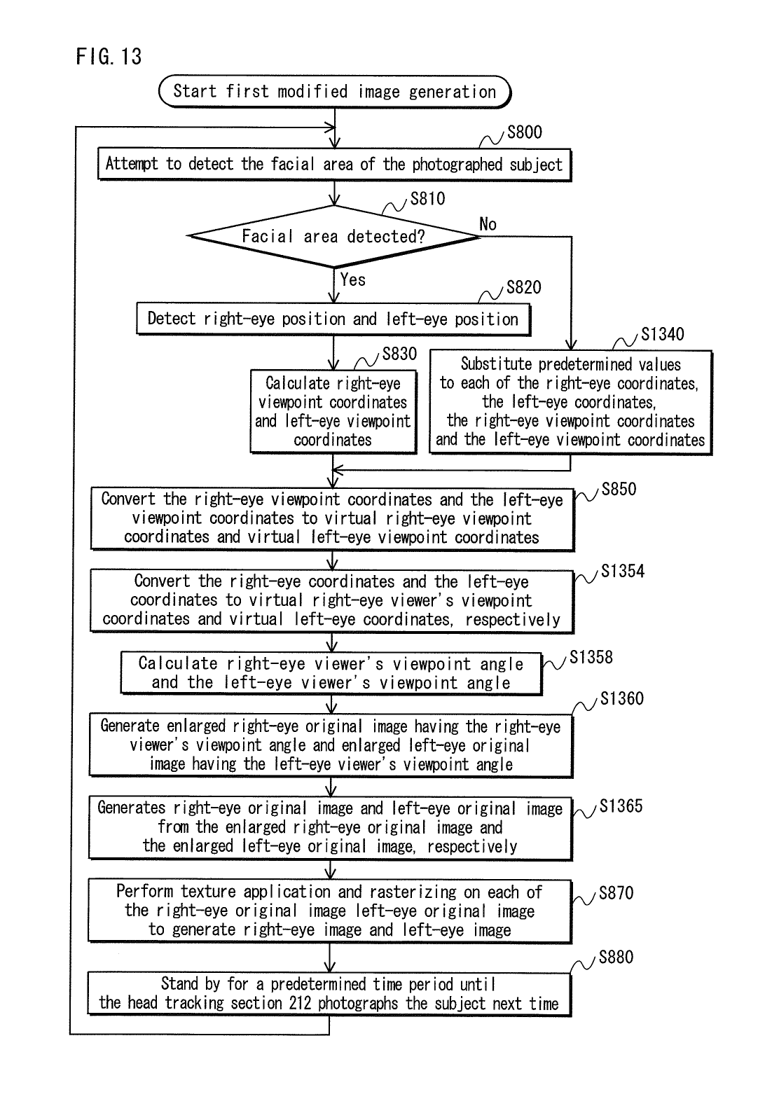

FIG. 13 is a flowchart of the first modification of the image generation.

As shown in the drawing, the first modification of the image generation is different from the image generation pertaining to Embodiment 1 (See FIG. 8) in the following points: Steps S1354 and S1358 are inserted between Steps S850 and S860; Step S1365 is inserted between StepsS860 and 5870; Step S840 is modified to be Step S1340; and Step S860 is modified to be Step S1360.

Therefore, the following explains Steps S1340, S1354, S1358, S1360 and S1365.

If the head tracking section 212 fails to detect the facial area in Step S810 (Step S810: NO), the coordinates converter section 222 substitutes predetermined values to each of the right-eye coordinates, the left-eye coordinates, the right-eye viewpoint coordinates and the left-eye viewpoint coordinates (Step S1340).

Upon completion of conversion from the right-eye viewpoint coordinates and the left-eye viewpoint coordinates to the virtual right-eye viewpoint coordinates and the virtual left-eye viewpoint coordinates respectively in Step S850, the coordinates converter section 1222 converts the right-eye coordinates and the left-eye coordinates to the virtual right-eye viewer's viewpoint coordinates and the virtual left-eye viewer's viewpoint coordinates in the virtual system respectively (Step S1354).

Upon completion of the conversion from the right-eye coordinates and the left-eye coordinates to the virtual right-eye viewer's viewpoint coordinates and the virtual left-eye viewer's viewpoint coordinates in the virtual coordinate system respectively, the viewpoint converter section 1135 calculates the right-eye viewer's viewpoint angle and the left-eye viewer's viewpoint angle (Step S1358). The right-eye viewer's viewpoint angle is the angle of view of the screen area from the virtual right-eye viewer's viewpoint represented by the virtual right-eye viewer's viewpoint coordinates calculated by the viewpoint converter section 1135. The left-eye viewer's viewpoint angle is the angle of view of the screen area from the virtual left-eye viewer's viewpoint represented by the virtual left-eye viewer's viewpoint coordinates calculated by the viewpoint converter section 1135.

Upon calculating the right-eye viewer's viewpoint angle and the left-eye viewer's viewpoint angle, the viewpoint converter section 1135 generates the enlarged right-eye original image having the right-eye viewer's viewpoint angle and the enlarged left-eye original image having the left-eye viewer's viewpoint angle (Step S1360).

Upon generation of the enlarged right-eye original image and the enlarged left-eye original image, the viewpoint converter section 1135 generates the right-eye original image and the left-eye original image from the enlarged right-eye original image and the enlarged left-eye original image, respectively (Step S1365).

<Consideration>

The following describes how the images, generated by the image generation device 1100 having the stated structure, are perceived by the viewer.

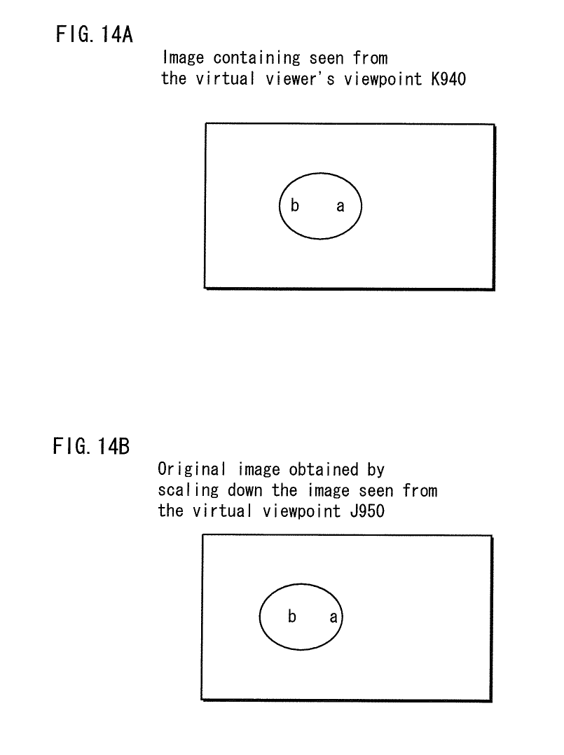

FIG. 14A shows an image containing an object 900 seen from the virtual viewer's viewpoint K940 in the case where the screen area 604 (See FIG. 12) is determined as the screen area used in the perspective projection conversion method. FIG. 14B shows an original image (hereinafter referred to as “scaled-down image”) obtained by scaling down an image containing the object 900 seen from the virtual viewpoint J950 in the case where the screen area 604 is determined as the screen area used in the perspective projection conversion method.

As shown in FIG. 12, the displacement of the virtual viewpoint J950 from the virtual reference point 930 is r times the displacement of the virtual viewer's viewpoint K940 from the virtual reference point 930. Therefore, as shown in FIGS. 14A and 14B, the view of the object 900 from the virtual viewpoint J950 is more similar to the lateral view of the object 900 than the view of the object 900 from the virtual viewer's viewpoint K940. Furthermore, the angle of the view of the image displayed on the screen surface 310 of the display 190 will coincide with the angle of view of the screen area 604 seen from the virtual viewpoint J950. Therefore, the image according to Modification 1 (i.e. the image shown in FIG. 14B) seen by the viewer looking at the display 190 from the viewpoint K440 shown in FIG. 4 causes less discomfort for the user than the image according to Embodiment 1 (i.e. the image shown in FIG. 10B) seen by the viewer looking at the display 190 from the viewpoint K440 shown in FIG. 4.

### <Modification 2>

The following describes an image generation device 1500 as yet another embodiment of an image generation device pertaining to one aspect of the present invention. The image generation device 1500 is obtained by modifying part of the image generation device 1100 pertaining to Modification 1.

<Overview>

The image generation device 1500 has the same hardware structure as the image generation device 1100 pertaining to Modification 1, but executes a partially different program than the program executed by the image generation device 1100 pertaining to Modification 1.

The image generation device 1100 pertaining to Modification 1 calculates the enlarged screen area so that the center point of the enlarged screen area coincides with the center point of the screen area. In contrast, the image generation device 1500 pertaining to Modification 2 calculates the enlarged screen area so that the side of the enlarged screen area that is in the direction of the displacement coincides with the side of the screen area that is in the direction of the displacement.

The following describes the structure of the image generation device 1500 pertaining to Modification 2 with reference to the drawings, focusing on the differences from the image generation device 1100 pertaining to Modification 1.

<Structure>

<Hardware Structure>

The image generation device 1500 has the same hardware structure as the image generation device 1100 pertaining to Modification 1. Hence, the explanation thereof is omitted.

<Functional Structure>

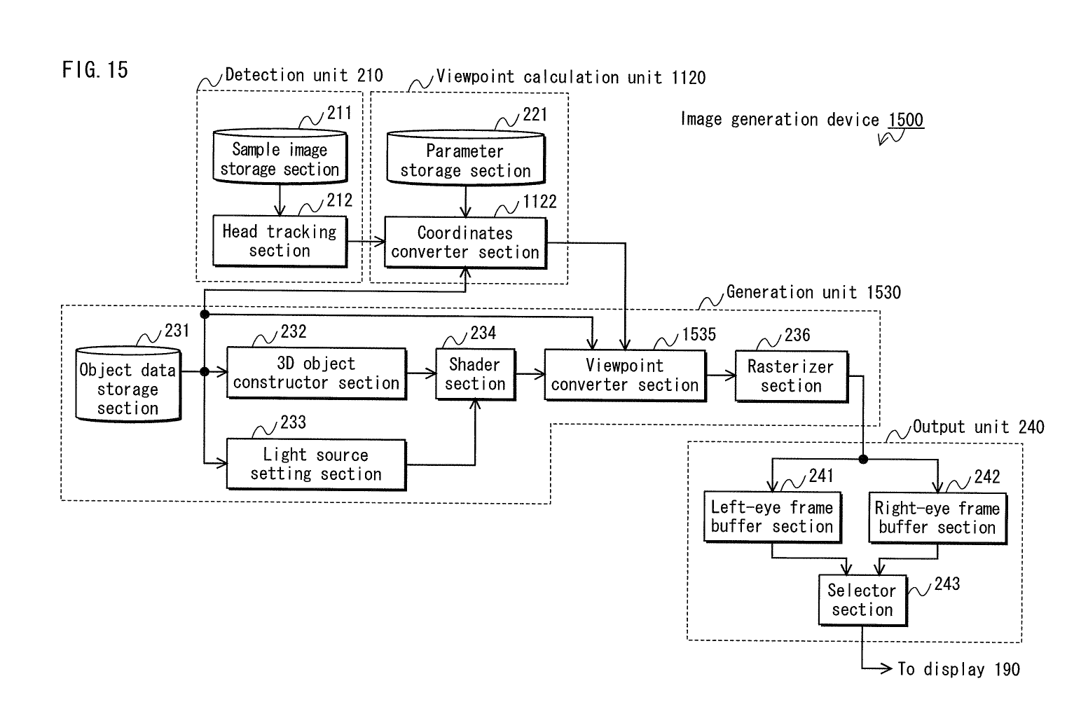

FIG. 15 is a functional block diagram showing primary functional blocks constituting the image generation device 1500.

As shown in the drawing, the image generation device 1500 includes a viewpoint converter section 1535, which is modified from the viewpoint converter section 1135 of the image generation device 1100 pertaining to Modification 1. According to this modification, the generation unit 1130 is modified to be a generation unit 1530.

The viewpoint converter section 1535 has the functions that are partially modified from the viewpoint converter section 1135 pertaining to Modification 1, and is connected to the coordinates converter section 1122, the object data storage section 231, the shader section 234 and the rasterizer section 236. The viewpoint converter section 1535 is realized with the processor 111 executing a program, and has a modified function for calculating the enlarged screen area, in addition to the view angle calculating function, the enlarged original image generating function and the image scaling down function of the viewpoint converter section 1135 pertaining to Modification 1.

Enlarged screen area calculating function with modification: the function of calculating an enlarged right-eye screen area, which is defined in the plane including the screen area and has the right-eye viewer's viewpoint angle with respect to the virtual right-eye viewpoint, and an enlarged left-eye screen area, which is defined in the plane including the screen area and has the left-eye viewer's viewpoint angle with respect to the virtual left-eye viewpoint. In this regard, the viewpoint converter section 1535 calculates the enlarged right-eye screen area so that the side of the enlarged right-eye screen area that is in the direction of the displacement coincides with the side of the screen area that is in the direction of the displacement, and calculates the enlarged left-eye screen area so that the side of the enlarged left-eye screen area that is in the direction of the displacement coincides with the side of the screen area that is in the direction of the displacement.

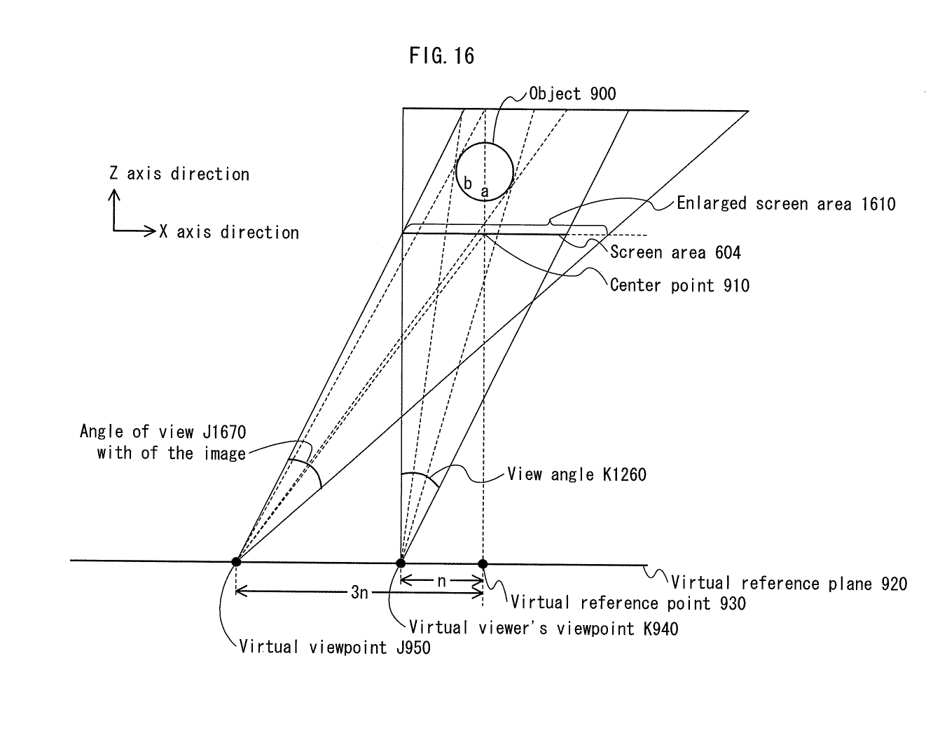

FIG. 16 is a schematic diagram showing a relationship among the object, the screen area, the enlarged screen area, the virtual viewer's viewpoint, and the virtual viewpoint.

In the drawing, the view angle J1670 is equal to the view angle K1260.

The enlarged screen area 1610 is defined in the plane including the screen area 604 and has the view angle J1670 with respect to the virtual viewer's viewpoint J950. The side of the enlarged screen area that is in the direction of the displacement coincides with the side of the screen area that is in the direction of the displacement.

<Consideration>

The following describes how the images, generated by the image generation device 1500 having the stated structure, are perceived by the viewer.

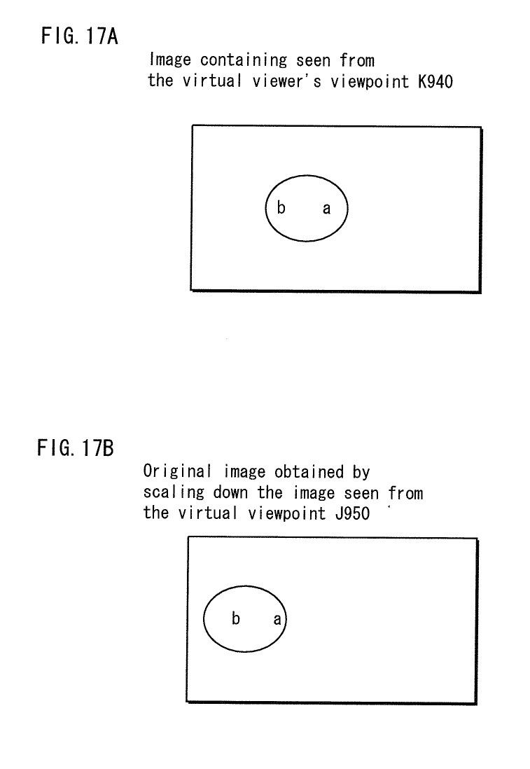

FIG. 17A shows an image containing an object 900 seen from the virtual viewer's viewpoint K940 in the case where the screen area 604 (See FIG. 12) is determined as the screen area used in the perspective projection conversion method.

FIG. 17B shows an original image (i.e. “scaled-down image”) obtained by scaling down an image containing the object 900 seen from the virtual viewpoint J950 in the case where the screen area 604 is determined as the screen area used in the perspective projection conversion method.

As shown in FIG. 17B, the image of the object 900 according to Modification 2 seen by the viewer looking at the display 190 from the viewpoint K440 shown in FIG. 4 is shifted leftward (i.e. in the direction of the displacement) from the image of the object 900 according to Modification 1 (i.e. the image shown in FIG. 14B) seen by the viewer looking at the display 190 from the viewpoint K440 shown in FIG. 4.

<Modification 3>

The following describes an image generation device 1800 as yet another embodiment of an image generation device pertaining to one aspect of the present invention. The image generation device 1800 is obtained by modifying part of the image generation device 100 pertaining to Embodiment 1.

<Overview>

The image generation device 1800 has the same hardware structure as the image generation device 100 pertaining to Embodiment 1, but executes a partially different program than the program executed by the image generation device 100 pertaining to Embodiment 1.

The image generation device 100 pertaining to Embodiment 1 obtains the viewpoint on the reference plane, which is parallel to the screen surface 310 of the display 190. The image generation device 1800 pertaining to Modification 3 obtains the viewpoint on a curved reference surface, which is curved so that the angle of view of the screen surface 310 of the display 190 will be constant.

The following describes the structure of the image generation device 1800 pertaining to Modification 3 with reference to the drawings, focusing on the differences from the image generation device 100 pertaining to Embodiment 1.

<Structure>

<Hardware Structure>

The image generation device 1800 has the same hardware structure as the image generation device 1100 pertaining to Modification 1. Hence, the explanation thereof is omitted.

<Functional Structure>

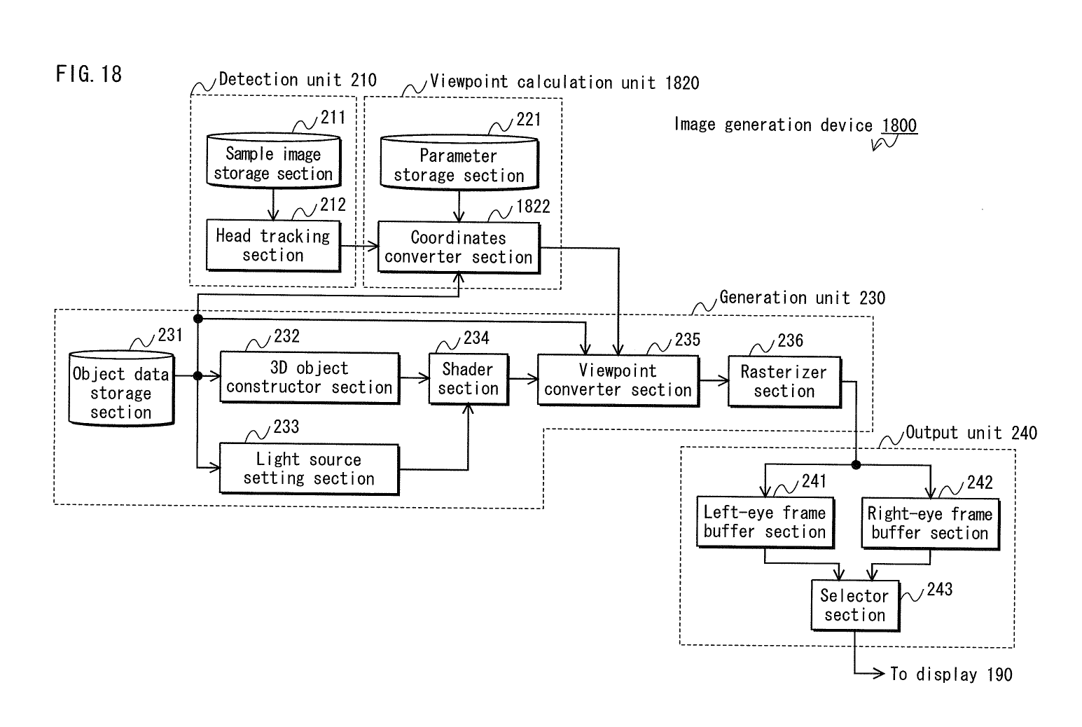

FIG. 18 is a functional block diagram showing primary functional blocks constituting the image generation device 1800.

As shown in the drawing, the image generation device 1800 includes a coordinates converter section 1822, which is modified from the coordinates converter section 222 of the image generation device 100 pertaining to Embodiment 1. According to this modification, the viewpoint calculation unit 220 is modified to be a viewpoint calculation unit 1820.

The coordinates converter section 1822 has the functions that are partially modified from the coordinates converter section 222 pertaining to Embodiment 1, and is connected to the head tracking section 212, the parameter storage section 221, the viewpoint converter section 235 and the object data storage section 231. The coordinates converter section 1822 is realized with the processor 111 executing a program, and has a modified function for determining the reference point and a modified function for calculating the viewpoint, in addition to the coordinates converting function of the coordinates converter section 222 pertaining to Embodiment 1.

Reference point determination function with modification: the function of obtaining, for each of the right eye and the left eye whose positions are detected by the head tracking section 212, the angle of view of the screen surface 310 of the display 190 with respect to the positions of the eyes, obtaining the curved reference surface composed of points at which the angle of view of the screen surface 310 is the same as the obtained view angle, and obtaining a reference point that is contained in the curved reference surface and corresponds in position to the center point of the screen surface 310. Here, “the point that is contained in the curved reference surface and corresponds in position to the center point of the screen surface” is the intersection point of a straight line that perpendicularly passes through the center point of the screen surface with the curved reference surface.

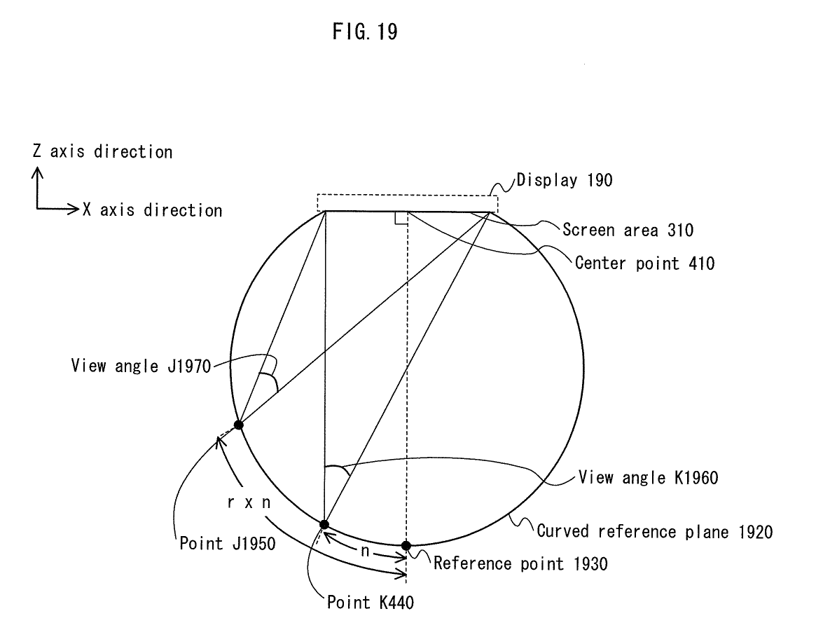

FIG. 19 is a schematic diagram showing a relationship between the screen surface 310 of the display 190 and the reference point 430 when the display 190 is seen from the positive side of the Y axis (see FIG. 3). In this example, the screen surface 310 is perpendicular to the Z axis.

In the drawing, the viewpoint K440 is the viewer's viewpoint detected by the head tracking section 212 (See FIG. 4). The viewpoint J1950 will be discussed later.

The view angle K1960 is the angle of view of screen surface 310 from the viewpoint K440.

The curved reference surface 1920 is composed of the points at which the angle of view of the screen surface 310 equals to the view angle K1960.

The reference point 1930 is the intersection point of a straight line that perpendicularly passes through the center point 410 of the screen surface 310 with the curved reference surface 1920.

The following further explains the function of the coordinates converter section 1822.

Viewpoint calculating function with modification: the function of obtaining the right-eye viewpoint and the left-eye viewpoint by, for each of the right-eye position and the left-eye position detected by the head tracking section 212, multiplying the displacement from the corresponding reference point in the corresponding curved reference surface by r. Here, obtaining the viewpoint by “multiplying the displacement in the curved reference surface by r” means defining a vector lying on the curved reference surface and having the start point at the reference point and the end point at the eye position, multiplying the magnitude of the vector by r while keeping the direction of the vector, and obtaining the end point of the vector after the multiplication as the viewpoint. Here, the viewpoint may be limited to a point in front of the screen surface 310 of the display 190 so that the viewpoint does not go behind the screen surface 310 of the display 190. In the following, the right-eye viewpoint and the left-eye viewpoint may be collectively referred to as the viewpoint, without making distinction between them.

In FIG. 19, the point J1950 is the viewpoint obtained by the coordinates converter section 1822 when the eye position detected by the head tracking section 212 is at the point K440.

<Consideration>

The following describes how the images, generated by the image generation device 1800 having the stated structure, are perceived by the viewer.

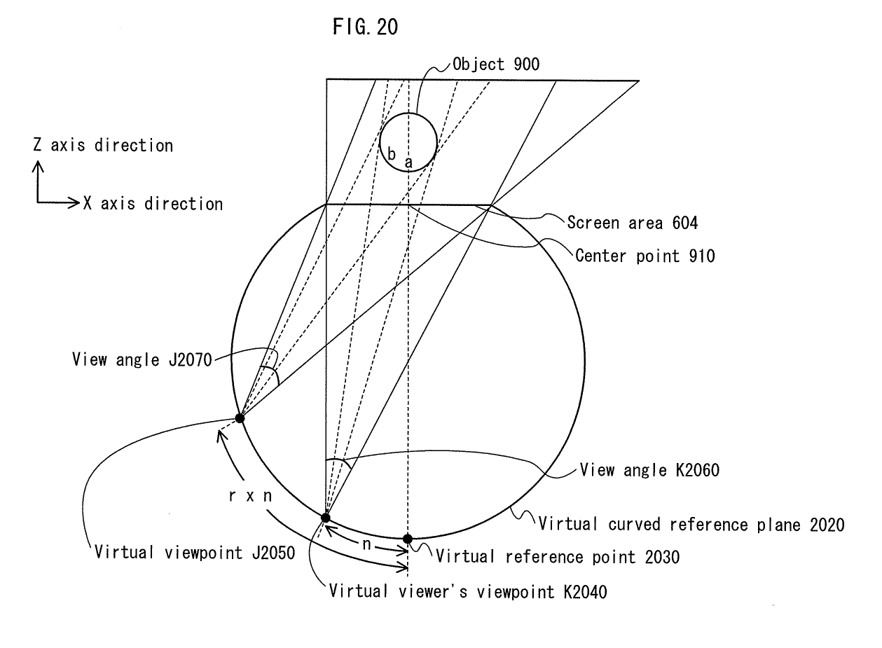

FIG. 20 is a schematic diagram illustrating an image generated by the image generation device 1800, and shows the positional relationship among the object, the screen area and the virtual viewpoint in the virtual space.

In the drawing, the screen area 604 is perpendicular to the Z axis, and the drawing shows the screen area 604 seen in the positive to negative direction of the Y axis (see FIG. 3) in the virtual space.

The virtual viewer's viewpoint K2040 indicates the point in the virtual space that corresponds to the point K440 in FIG. 19. That is, the viewpoint indicates the point in the virtual space that corresponds to the viewer's viewpoint detected by the head tracking section 212.

The virtual viewpoint J2050 is the point in the virtual space that corresponds to the point J1950 in FIG. 19. That is, the virtual viewpoint J2050 is the virtual viewpoint obtained by the coordinates converter section 1822.

The virtual curved reference surface 2020 is a curved surface in the virtual space that corresponds to the curved reference surface 1920 in FIG. 19.

The virtual reference point 2030 is the point in the virtual space that corresponds to the reference point 1930 in FIG. 19.

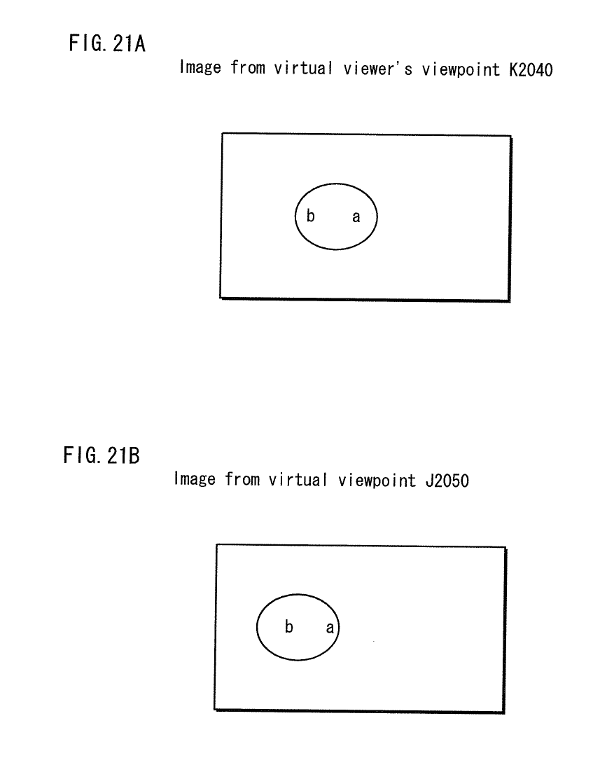

FIG. 21A shows an image containing an object 900 seen from the virtual viewer's viewpoint K2040 in the case where the screen area 604 is determined as the screen area used in the perspective projection conversion method. FIG. 21B shows an image containing the object 900 seen from the virtual viewpoint J2050 in the case where the screen area 604 is determined as the screen area used in the perspective projection conversion method.

As shown in FIG. 20, the displacement of the virtual viewpoint J2050 from the virtual reference point 2030 is r times the displacement of the virtual viewer's viewpoint K2040 from the virtual reference point 2030. Therefore, as shown in FIGS. 21A and 21B, the view of the object 900 from the virtual viewpoint J2050 is more similar to the lateral view of the object 900 than the view of the object 900 from the virtual viewer's viewpoint K2040.

As described above, the viewer looking at the display 190 from the point K440 shown in FIG. 19 can get a view of the image on the display 190 as if the viewer is looking at the display 190 from the point J1950 obtained by multiplying the displacement from the reference point 1930 by r. Furthermore, the angle of the view of the image displayed on the screen surface 310 of the display 190 will coincide with the angle of view of the screen area 604 seen from the virtual viewer's viewpoint K2040 and the angle of view of the screen area 604 seen from the virtual viewpoint J2050. Therefore, the image according to Modification 3 (i.e. the image shown in FIG. 21B) seen by the viewer looking at the display 190 from the point K440 shown in FIG. 4 (or FIG. 19) causes less discomfort for the user than the image according to Embodiment 1 (i.e. the image shown in FIG. 10B) seen by the viewer looking at the display 190 from the point K440 shown in FIG. 4.

### <Other Modifications>

The head tracking section 212 may detect the viewer's viewpoint with a small variation for each frame, depending on the degree of accuracy of the ranging device 131. In this case, a low-pass filter may be used to eliminate the variations in detecting the viewer's viewpoint.

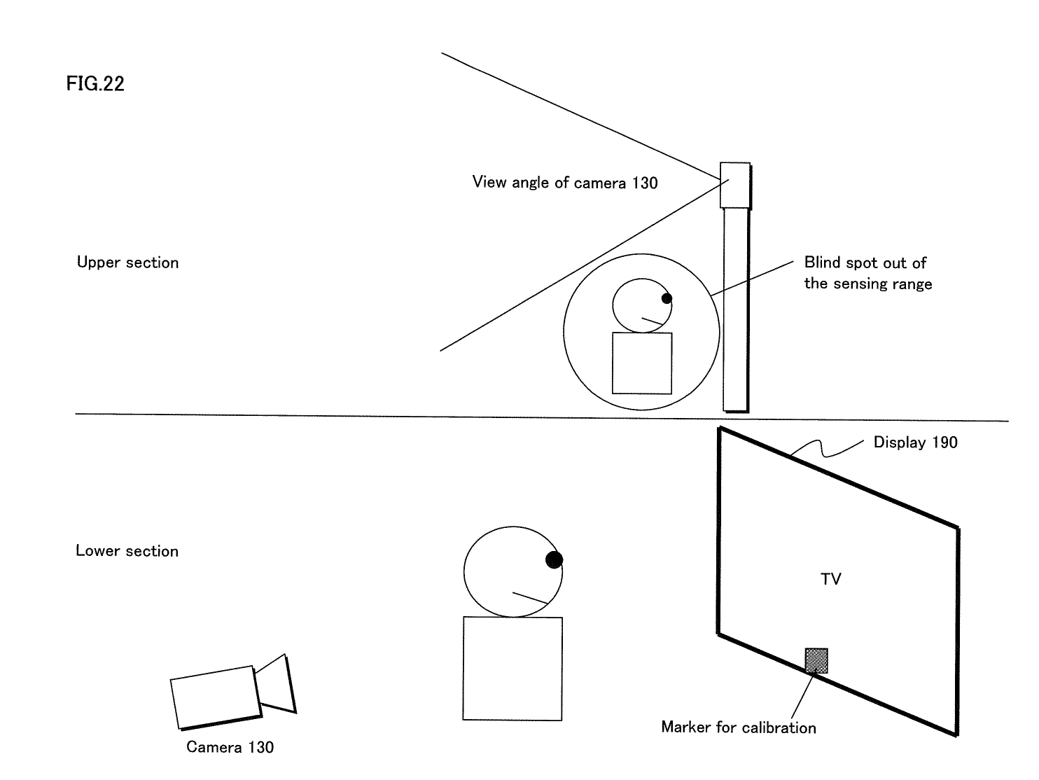

The camera 130 may be located on the top part of the display 190. If this is the case, however, as shown in the upper section of FIG. 22, an area close to the display 190 will be a blind spot, which is out of the sensing range of the ranging device 131 and the imaging device 132, and the camera 130 cannot detect the area. In order to detect a viewer close to the display 190, the camera 130 may be located behind the viewer as shown in the lower section of FIG. 22. If this is the case, the obtained X and Y values are inverted, and the Z value is obtained by subtracting the Z value from the distance between the display 190 and the camera 130 which is obtained in advance. To obtain the distance between the display 190 and the camera 130, a marker image may be provided on the display 190. With the marker image, the head tracking section 212 can easily measure the distance to the display 190 by performing pattern matching with the marker. With such a structure, the head tracking section 212 can detect the viewer close to the display 190.

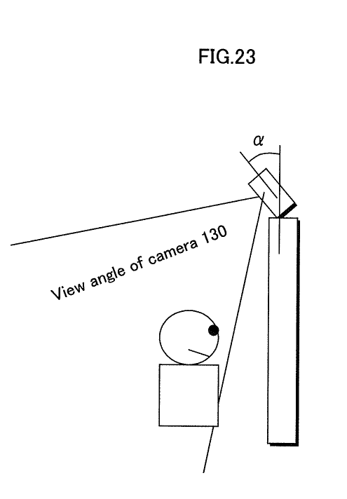

In order to detect a viewer close to the display 190, the camera 130 may be located in a tilted position above the display 190 as shown in the lower section of FIG. 23. If this is the case, the tilt angle α formed by the camera 130 and the display 190 is used for correcting the coordinates. To obtain the tilt angle α, the camera 130 may be provided with a gyro sensor. With such a structure, the head tracking section 212 can detect the viewer close to the display 190.

In order to detect a viewer close to the display 190, the camera 130 may be rotatably located above the display 190 so that the camera 130 can track the viewer. The camera 130 is rotatably configured so that the viewer, whose face is the subject of the detection, will be included in the image captured by the camera 130.

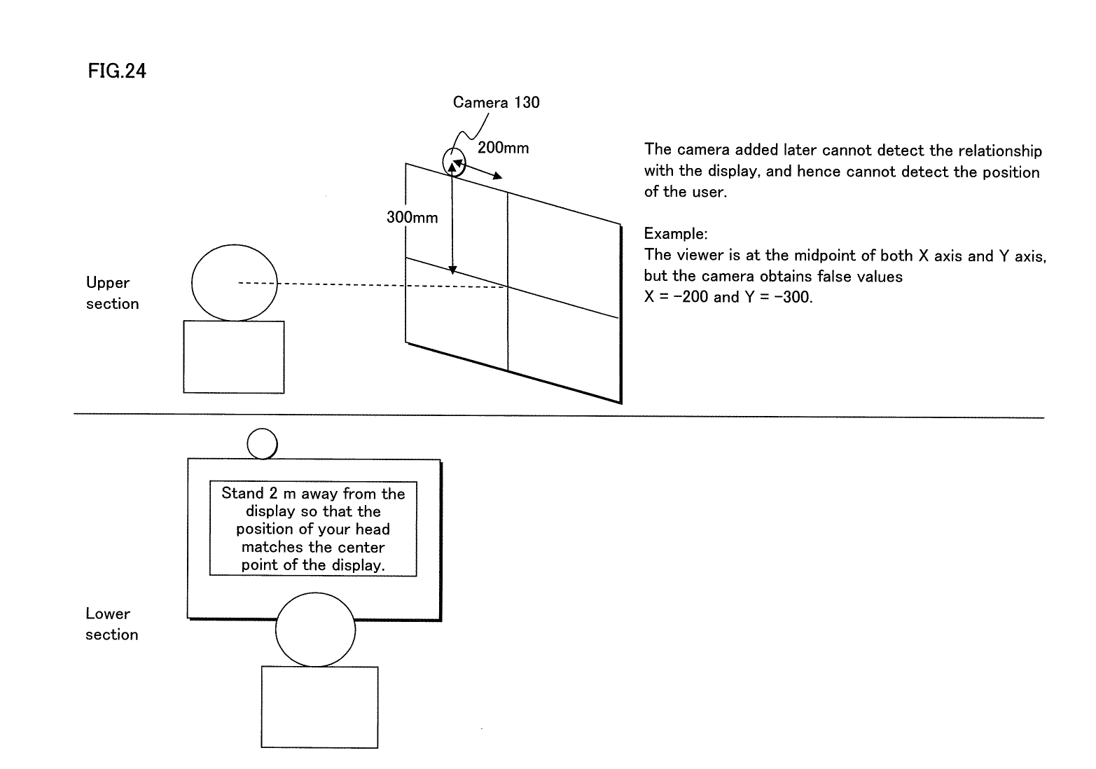

In the case of a system where the camera 130 is added later, there is a problem that the system cannot detect the relationship between the camera 130 and the display 190 and cannot track the viewer's viewpoint. In the case of the upper section of FIG. 24, the viewer is at the midpoint of both X axis and Y axis. However, the camera 130 added later cannot detect the relationship with the display 190, and hence cannot correct the difference between the position of the camera 130 and the position of the center point of the display 190. As a result, in the case of the upper section of FIG. 24, the camera 130 obtains, as the values indicating the position of the viewer, false values X=−200 mm, and Y=−300 mm. Considering the above, the viewer may be prompted to stand so that the center point of the head of the viewer coincides with the center point of the display 190 as shown in the lower section of FIG. 24, and the camera 130 may detect the relationship with the display 190 with reference to the position of the viewer. For example, in the case as shown in the upper section of FIG. 24, when the viewer stands in front of the display 190 so that the center point of the viewer's head coincides with the center point on the display 190, the camera 130 acquires X=−200 mm and Y=−300 mm as the position of the viewer's head. However, before the subsequent head tracking, the position is corrected to coincide with the center point (X=0 mm, Y=0 mm).

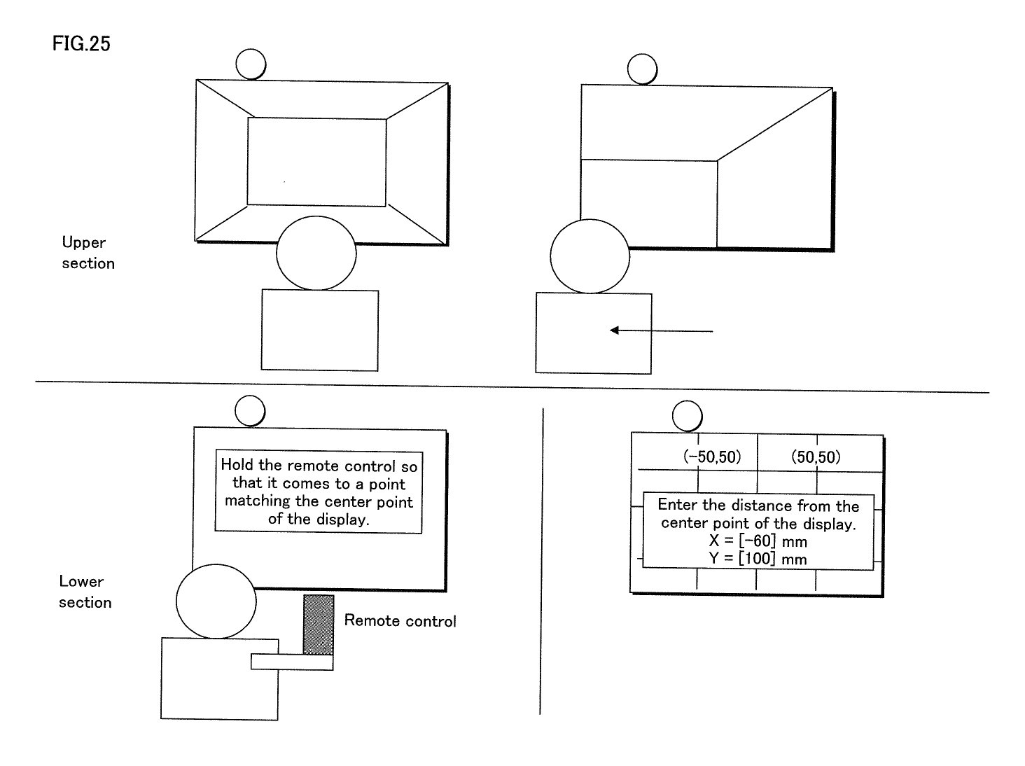

As shown in the upper section of FIG. 25, a virtual box with a depth may be prepared on the display 190, and the viewer may be instructed to stand at one of the four corners (upper left, upper right, lower right, lower left). If this is the case, calibration may be performed to adjust the coordinates of the box via GUI or the like so that the straight line connecting a corner of the screen and a corner of the virtual box is in the line of sight of the viewer. With such a structure the viewer can perform calibration with intuitive operations. Besides, the viewer can perform calibration with high accuracy by using information of multiple points.

As another calibration method, the image generation device 100 may perform sensing of an object with a known physical size, as shown on the left side of the lower section of FIG. 25. For example, the image generation device 100 may have information of the shape of the remote control used for operating the display 190, and correct the coordinates by prompting the viewer to place the remote control in front of the display 190, as shown on the left side of the lower section of FIG. 25. Since the image generation device 100 has the information of the shape of the remote control, it can easily recognize the remote control. Also, by using the size of the remote control, the image generation device 100 can calculate the depth at the position of the remote control based on the relationship between the size on the camera 130 and the actual size. Not only a remote control, common objects such as a PET bottle and a smart phone may be used as well.

Alternatively, as shown on the right side of the lower section of FIG. 25, the display 190 may display a grid showing the distance from the center point, and the viewer may be prompted to enter the distance from the center point to the camera 130. This structure can obtain the positional relationship between the camera 130 and the display 190, and can make the correction.

Note that the size information of the display 190 may be extracted from the High-Definition Multimedia Interface (HDMI) information, or set by the user via GUI or the like.

When there are multiple people in front of the display 190, the subject of the head tracking can be easily selected if a person making a predetermined gesture such as holding up the hand can be detected. If this is the case, the head tracking section 212 may be given the function of recognizing the gesture of “holding up the hand” by pattern matching or the like. The head tracking section 212 memorizes the face of the person who made the gesture, and tracks the head of the person. When there are multiple people in front of the TV, the tracking subject person may be selected via a GUI or the like from the image of the people shown on the display screen, instead of selecting the subject by using a gesture.

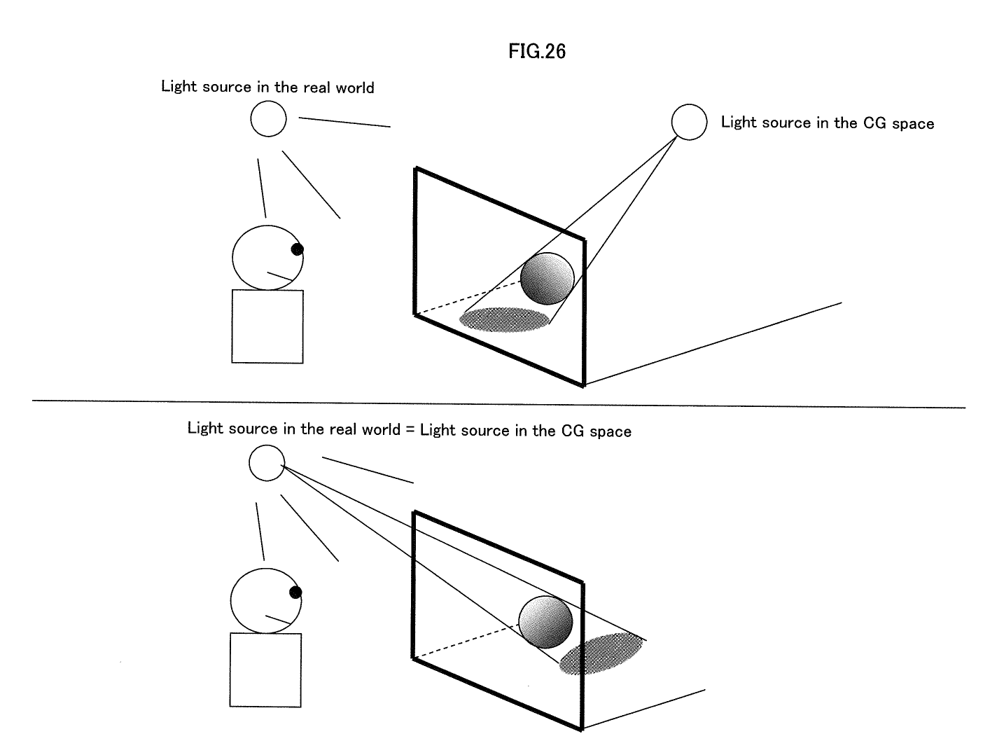

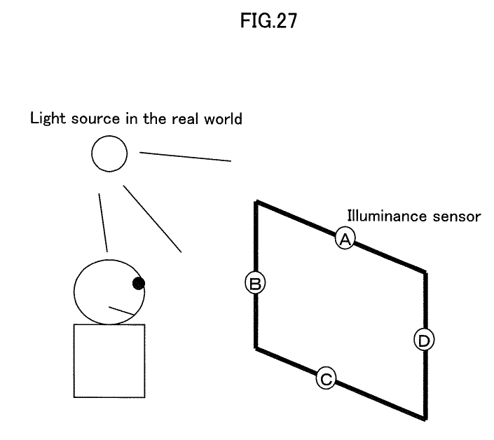

Regarding positioning of the light source, the sense of realism can be enhanced by locating the virtual light source so as to match the light source in the real world (such as lighting equipment) in terms of the position as shown in FIG. 26. In the upper section of FIG. 26, the light source in the real world is located above the viewer, whereas the light source in the CG is located behind the 3D model (i.e. in the direction away from the viewer). Therefore, the shade and shadow cause discomfort for the viewer. In contrast, when the position of the light source in the CG space matches the position of the light source in the real world as shown in the lower section of FIG. 26, the discomfort caused by the shade and shadow will be resolved and the sense of realism can be enhanced. Considering the above, there is a demand to obtain the positional information and the intensity of the light source in the real world. To obtain the positional information and the intensity of the light source in the real world, illuminance sensors may be used as shown in FIG. 27. Illuminance sensors are sensors for measuring the amount of light, and used for turning on a light source in a dark place and turning on a light source in a bright place, for example. When a plurality of illuminance sensors are arranged as shown in FIG. 27, the direction of the light can be detected according to the illuminance values. For example, in FIG. 27, when the illuminance values obtained by the sensors A and B are high and the illuminance values obtained by the sensors C and D are low, this shows that the light is coming from the direction of the top right corner. To detect the position of the light source by using sensors as described above, the brightness of the panel of the display 190 may be reduced to prevent the interference of light. To obtain the positional information of the light source in the real world, it is possible to allow user to enter the information via GUI or the like. If this is the case, the image generation device 100 instructs the viewer to move to the point immediately below the light source, and to enter the distance between the head of the viewer and the light source. Then, the image generation device 100 obtains the positional information by obtaining the head position of the viewer with the head tracking section 212, and obtains the position by adding the distance between the head of the viewer and the light source in the real world to the Y value of the positional information. To obtain the position of the light source in the real world, the brightness of the image photographed by the camera 130 may be used.

In the description above, the right-eye position and the left-eye position are detected by matching using sample images. However, the eye positions may be detected by first detecting the center point of the face from the detected facial area, and calculating the eye positions with reference to the position of the center point. For example, when the coordinates of the center point of the facial area is (X1, Y1, Z1), the coordinates of the left eye position may be defined as (X1−3 cm, Y1, Z1), and the coordinates of the right eye position may be defined as (X1+3 cm, Y1, Z1). Furthermore, the virtual right-eye viewpoint and the virtual left-eye viewpoint may be obtained by first calculating the virtual viewpoint corresponding to the center point of the face, and then calculating the virtual right-eye viewpoint and the virtual left-eye viewpoint from the virtual viewpoint. For example, when the coordinates of the virtual viewpoint corresponding to the center point of the face is (X1, Y1, Z1), the coordinates of the virtual left-eye viewpoint may be defined as {X1−(3 cm*RealToCG coefficient), Y1, Z1} and the coordinates of the virtual right-eye viewpoint may be defined as {X1+(3 cm*RealToCG coefficient), Y1, Z1}.

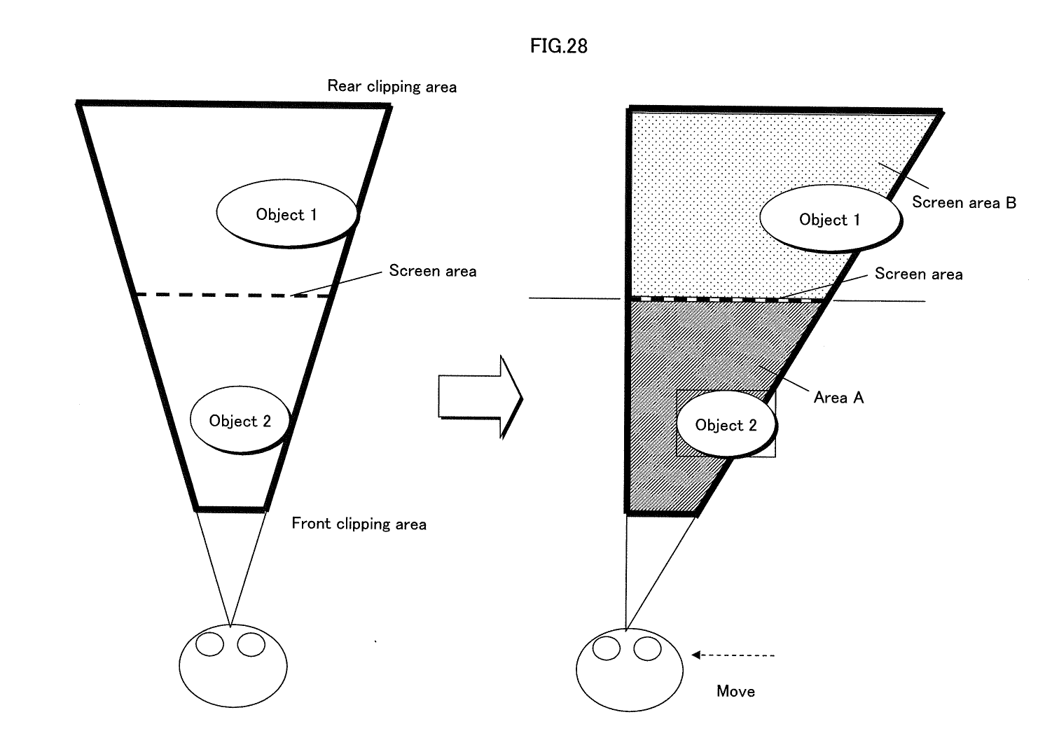

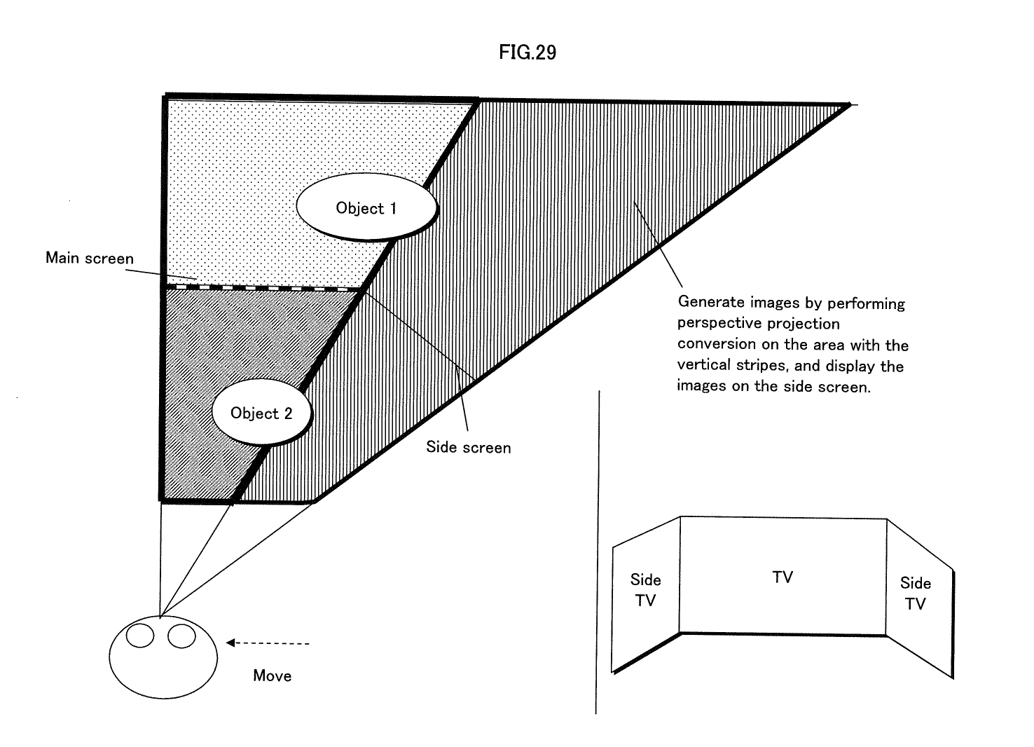

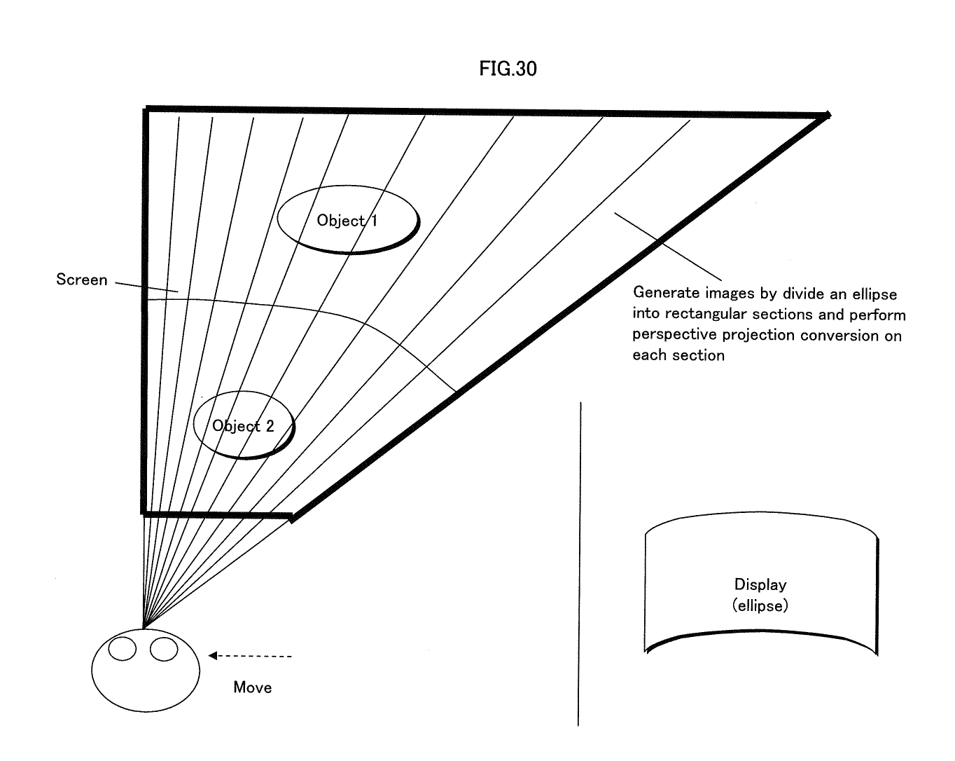

To display the object without causing discomfort for the viewer, the coordinates of the object may be corrected to be included within the viewing frustum with respect to the space closer to the viewer than the screen area. The left side section of FIG. 28 shows the relationship between the coordinates of objects and a viewer on a CG. In this case, the entire bodies of the object 1 and the object 2 are contained in the range of the frustum. However, after the viewpoint moves as shown in the right section of the drawing, the object 1 and the object 2 extend off the frustum. The object 1 does not cause discomfort because it is in the area that cannot be seen on the screen area. The object 2, however, causes the viewer's great discomfort because the part that should be seen is missing. In view of the above, when the depth position of the CG model is closer to the viewer than the depth position of the screen area in the CG coordinate system, the coordinates of the CG model are corrected so that the CG model does not go beyond the space (Area A) that is closer to the viewer than the screen area within the viewing frustum. As a result, the viewer can see objects in front of the screen area without feeling discomfort. To prevent the object from going off the area A, the cube surrounding the object may be virtually formed as a model, and the inclusion relationship between the cube and the area A is calculated. When the object goes beyond the area A, the object is moved horizontally or backward (away from the user). In such cases, the object may be scaled down. Objects may always be located within the area B (the space on the rear side of the screen area in the viewing frustum (the space away from the viewer)). By providing additional screens on both sides as shown in the right side section of FIG. 29, the viewable area of the object in the front area increases as shown in the left side section of FIG. 29, because the angle of view of the object from the viewer increases. If this is the case, the viewpoint converter section 235 performs perspective projection conversion on the side displays with respect to the viewer's position and displays the images not only on the center display but on the side displays. When the display is shaped like an ellipse as shown in FIG. 30, the ellipse may be divided into a plurality of rectangular sections, and images may be displayed on the sections by performing the perspective projection conversion on each of the sections.

In the case of a 3D television requiring the use of glasses with an active shutter or polarized glasses, the right-eye position and the left-eye position may be detected by detecting the shape of the glasses by pattern matching.

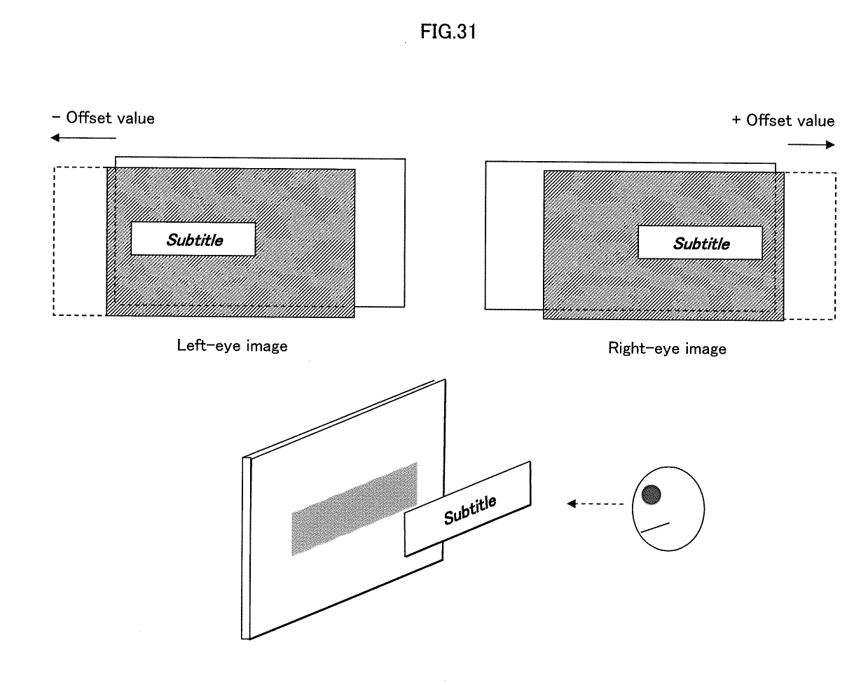

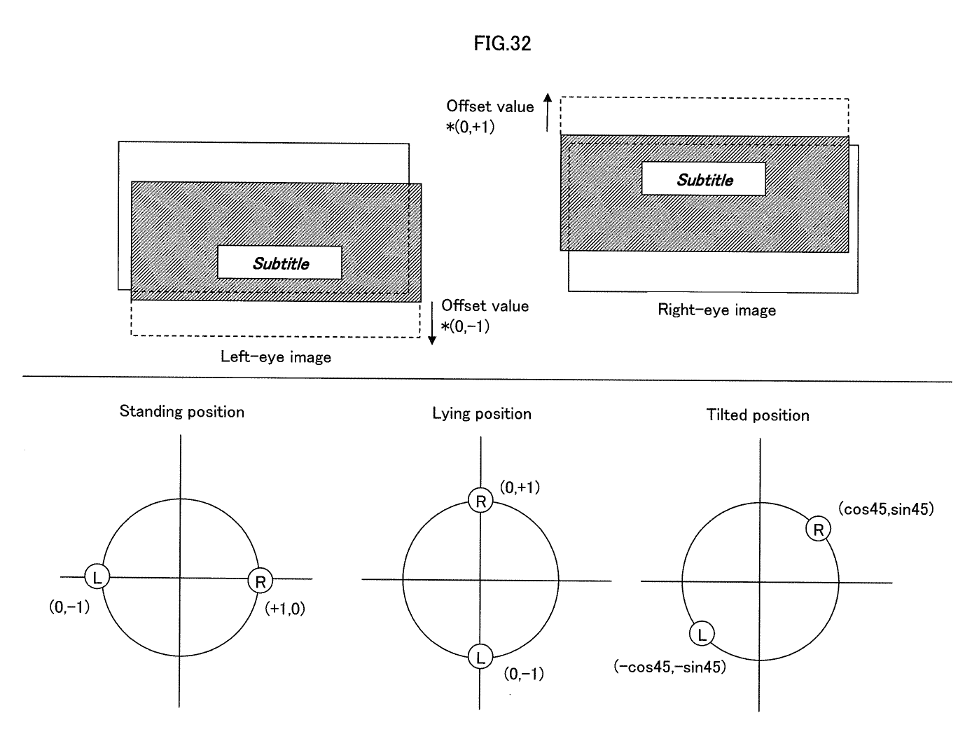

The “1 plane+offset” method shown in FIG. 31 is known as a method for generating 3D images. The “1 plane+offset” method is used for displaying simple 3D graphics such as subtitles and menus according to a 3D video format such as the Blu-ray™ 3D. The “1 plane+offset” method generates a left-eye image and a right-eye image by shifting a plane, on which 2D graphics are rendered, to the left and the right by a specified offset. By composing the images into a plane of video or the like, the disparity images for the left eye and the right eye can be formed as shown in FIG. 31. Thus, the plane image is given the depth. The viewer can perceive the plane image as if it is popping up from the display. In the description above, the generation unit 230 of the image generation device 100 generates 3D computer graphics. When a 3D image is generated by the “1 plane+offset” method, the plane shift may be performed by obtaining the inclination of the right eye and left eye. That is, as shown in the upper section of FIG. 32, when the viewer is in the lying position and the left eye is located below the right eye, an offset is given in the vertical direction to generate the left eye and right eye images. Specifically, as shown in the lower section of FIG. 32, the offset is given as a vector having a magnitude of 1 according to the positions of the eyes. With such a structure, in a free viewpoint image, “1 plane+offset” 3D image can be generated in an appropriate form according to the positions of the eyes of the viewer.

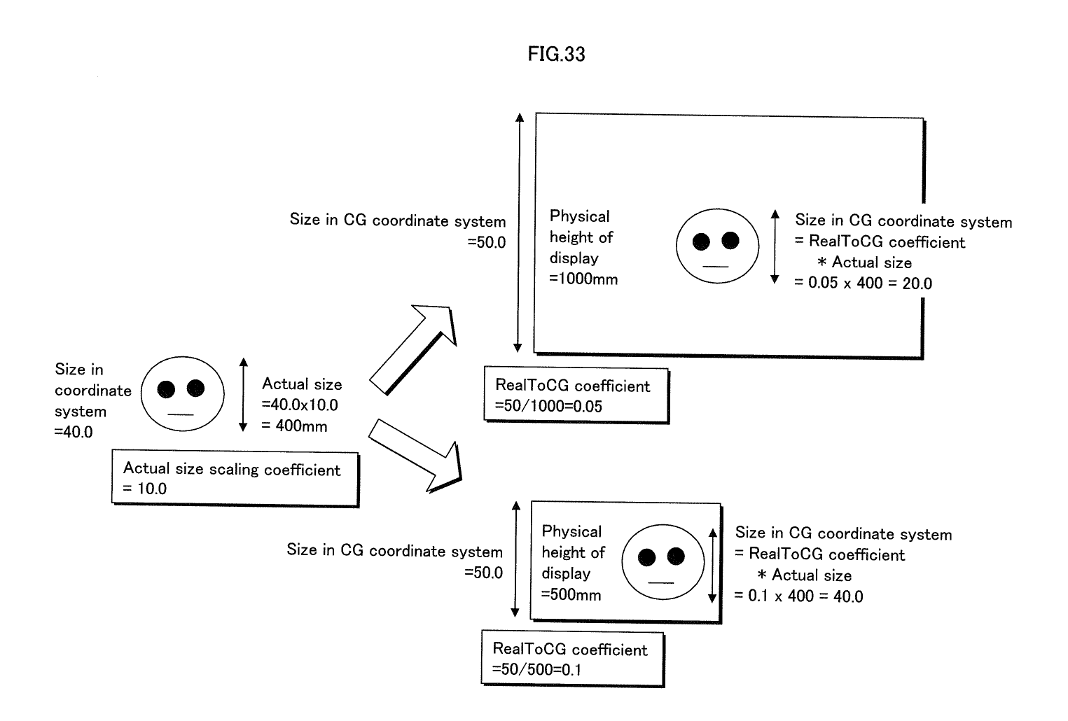

To enhance the sense of realism, it is desirable that the object is displayed in its actual size. For example, when displaying a model person on the screen, it is desired that the person is displayed in his/her actual size. The following explains this method with reference to FIG. 33. As shown in FIG. 33, the object has “actual size scaling coefficient” in addition to the coordinates data. This information is used for converting the coordinates data of the object to the actual-size of the object in the real world. In this example, the actual-size scaling coefficient is defined as a coefficient used for converting the coordinates to values in mm. For example, when the actual-size scaling coefficient is 10.0 and the object size is 40.0, the actual size in the real world can be obtained as follows: 40.0×10.0=400 (mm). The following explains a method used by the generation unit 230 to convert an object to coordinates information on the CG so that the object can be displayed in the real size. To convert the object to the coordinates information on the CG, the generation unit 230 first scales the object to the actual size by using the actual-size scaling coefficient, and then multiplies the size by the RealToCG coefficient. For example, FIG. 33 explains the case where the object is displayed on a display screen having a physical size of 1000 mm and a display screen having a physical size of 500 mm. In the case of the display having a physical size of 1000 mm, since the RealToCG coefficient for the model shown in FIG. 33 is 0.05, the coordinates on the CG can be obtained by multiplying the actual size 400 mm of the CG model by the coefficient 0.05, and the result is 20.0. In the case of the display having a physical size of 1000 mm, since the RealToCG coefficient for the model shown in FIG. 33 is 0.1, the coordinates on the CG can be obtained by multiplying the actual size 400 mm of the CG model by the coefficient 0.1, and the result is 40.0. As described above, the object can be rendered in the actual size of the real world by including the actual-size scaling coefficient into the model information.

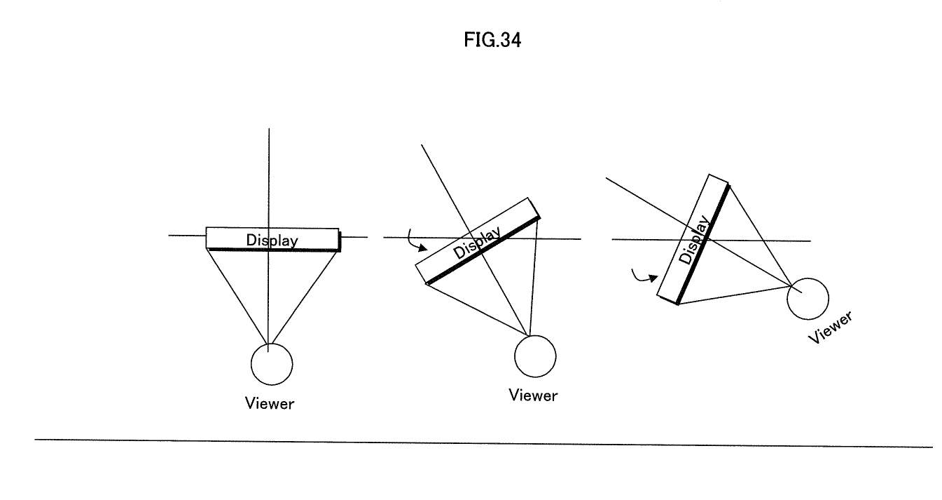

As shown in FIG. 34, the display may be rotated about the straight line connecting the display center and the viewer, according to the movement of the viewer. If this is the case, the display is rotated so that the camera 130 can always face toward the viewer. Such a structure allows the viewer to see the CG object from all directions.

The value of r may be adjusted according to the physical size (in inch) of the display. When the display is in a large size, the viewer needs a large movement to see behind the object, and therefore r is to be increased. When the display is in a small size, r is to be decreased. With such a structure, it is possible to set an appropriate ratio without adjustment by the user.

In addition, the value of r may be adjusted according to the size of body of the viewer, such as the height. Since the motion of an adult can be larger than a child, the value of r for a child may be set larger than for an adult. With such a structure, it is possible to set an appropriate ratio without adjustment by the user.

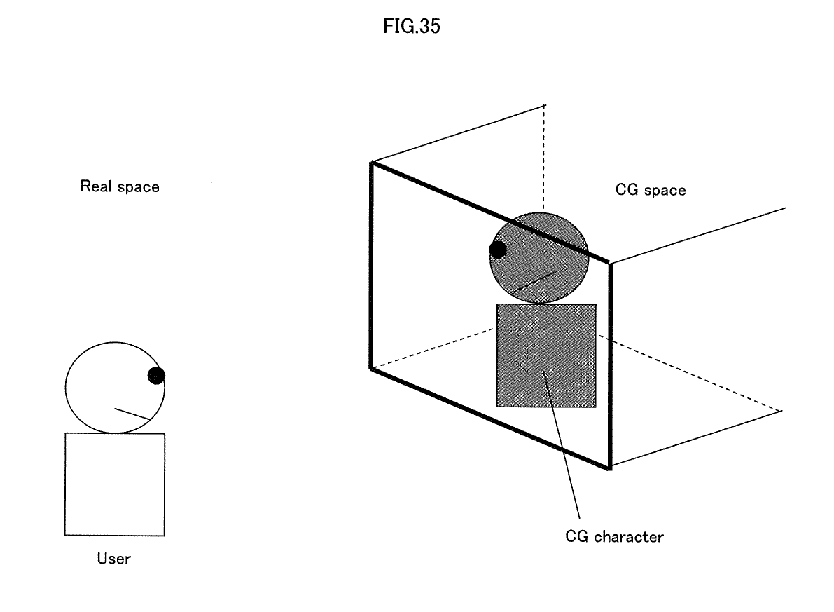

FIG. 35 shows an example application of the image generation device 100. In this application, the user communicates with a CG character in a CG space to play a game, for example. For example, a game in which the user trains CG characters, or a game in which the user makes friends with or dating with CG characters can be assumed. The CG character may do jobs or the likes as an agent of the user. For example, if the user says “I want to go to Hawaii”, the CG character searches for travel plans on the Internet, and shows the results to the user. With the sense of realism of the free-viewpoint 3D images, the user can easily communicate with the CG character, and can feel affection for the character.

The following explains problems and solutions in such an application.

To enable the user to feel that he/she is actually in the same space as the CG character, the image generation device 100 may be provided with a “temperature sensor”. The CG character may change clothes according to the room temperature obtained by the “temperature sensor”. For example, when the room temperature is low, the CG character wears layers of clothes, and when the room temperature is high, the CG character wears less clothing. This provides the sense of unity to the user.

In recent years, celebrities such as pop idols have increasing opportunities for conveying their own thoughts via the Internet by using tweets, blogs or the likes. The application provides a means for representing such text information with added sense of realism. A CG character is formed by modeling a celebrity such as a pop idol, and URL of his/her tweet or blog or access API information is incorporated into the CG character. When the tweet or the blog is updated, the playback device acquires the text information of the tweet or the blog via the URL or the access API, and moves the coordinates of the vertex of the mouth part of the CG character so that the character looks like speaking, while generating the text information according to the voice characteristics of the celebrity. This makes the user feel that the celebrity is actually speaking the words of the tweet or the blog, and have the sense of realism compared to the case of simply reading the text. To further enhance the sense of realism, audio stream of the tweet or the blog and motion capture information of the movement of the mouth according to the audio stream may be acquired. In such a case, the playback device moves the vertex coordinates according to the motion capture information for the movement of the mouth, and more naturally reproduces the speech of the celebrity.

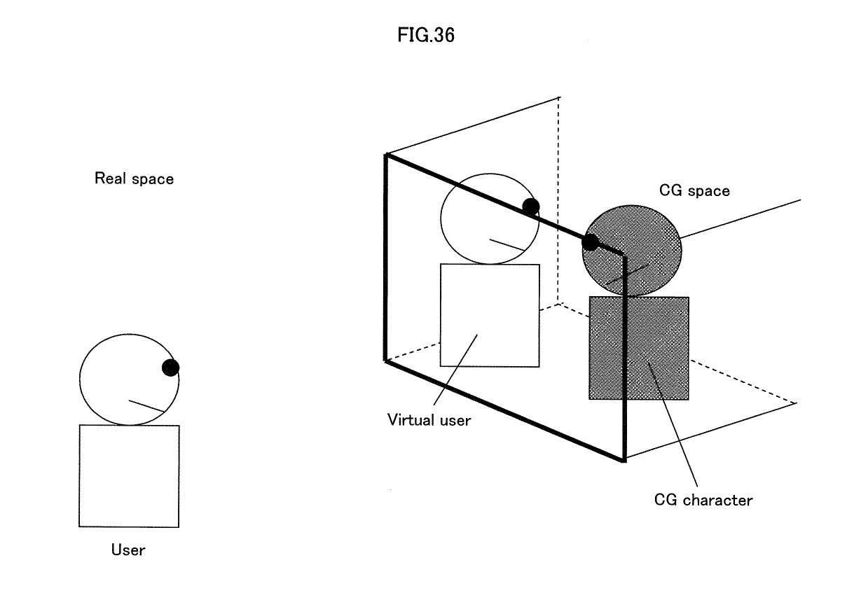

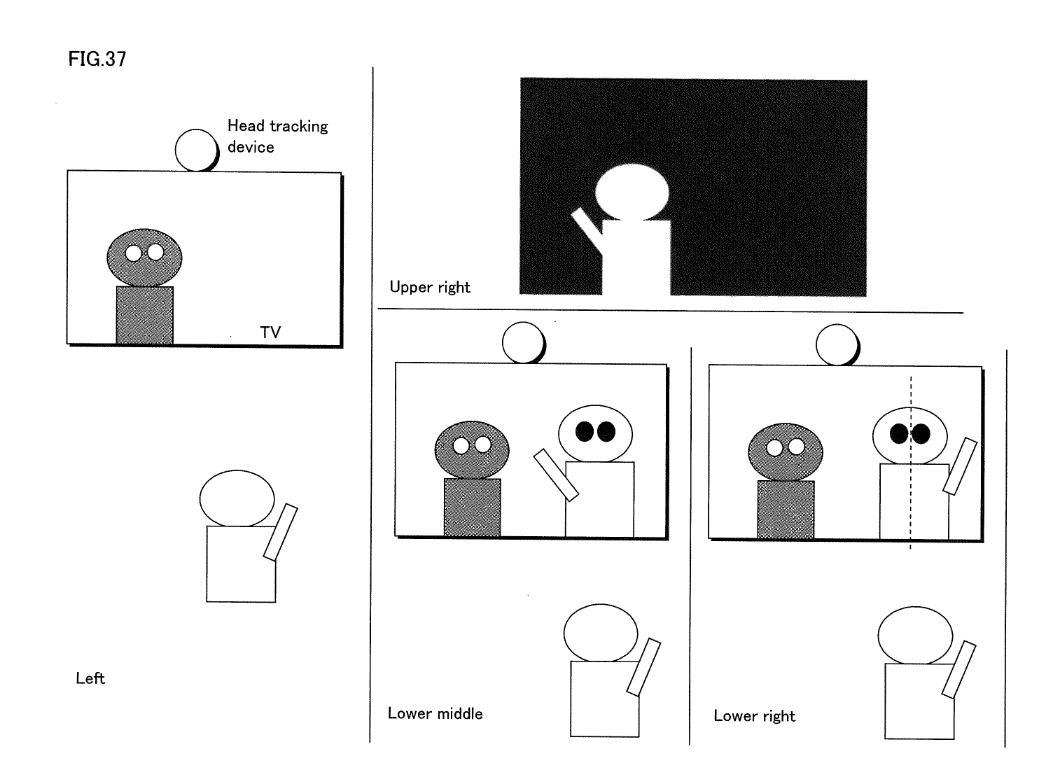

As shown in FIG. 36, if the user can virtually go inside the screen, the user can more smoothly communicate with the CG character. The following explains a structure which allows the user to virtually go inside the screen, with reference to FIG. 37. In the case of the left section in FIG. 37, when the TV (e.g. the display 190) is provided with a head tracking device (e.g. the camera 130), the head tracking section 212 recognizes the user by head tracking, and extracts the body part of the user from a depth map showing the depth information of the entire screen. For example, as shown in the upper right section in the drawing, the head tracking section 212 can distinguish between the background and the user by using a depth map. The user area so specified is cut out from the image photographed by the camera. This is used as the texture in the CG world. This image as the texture is applied to a human model, and renders the character in the CG world by adjusting the user position (represented by X and Y coordinates, and the Z value may be inverted, for example). In this case, the character will be displayed as shown in the lower middle part of FIG. 37. In this case, however, the image is left and right reversed since it is photographed from the front side, and causes discomfort for the user. Therefore, the texture of the user may be horizontally reversed again with respect to the Y axis, as shown in the lower right section of FIG. 37. In this way, it is preferable that a mirror image of the user in the real world is displayed on the screen. This allows the user to virtually go inside the screen without feeling discomfort.

In order to show the user's back side on the screen instead of showing the user's face on the screen as shown in the lower right section of FIG. 37, the head tracking device may be located behind the user. Alternatively, the CG model may be generated from the depth map information of the front side, and a picture or a video of taken from the back side, as the texture, may be applied to the model.

As an example application of the system allowing the user to virtually go inside the screen where the CG character exists, a walk in desired scenery may be realized. In such a case, the system plays back scenery images on the background and combines the CG model and the user to the scenery. Thus, the user can enjoy a walk with the sense of realism. The scenery images may be distributed in the form of optical discs such as BD-ROMs.

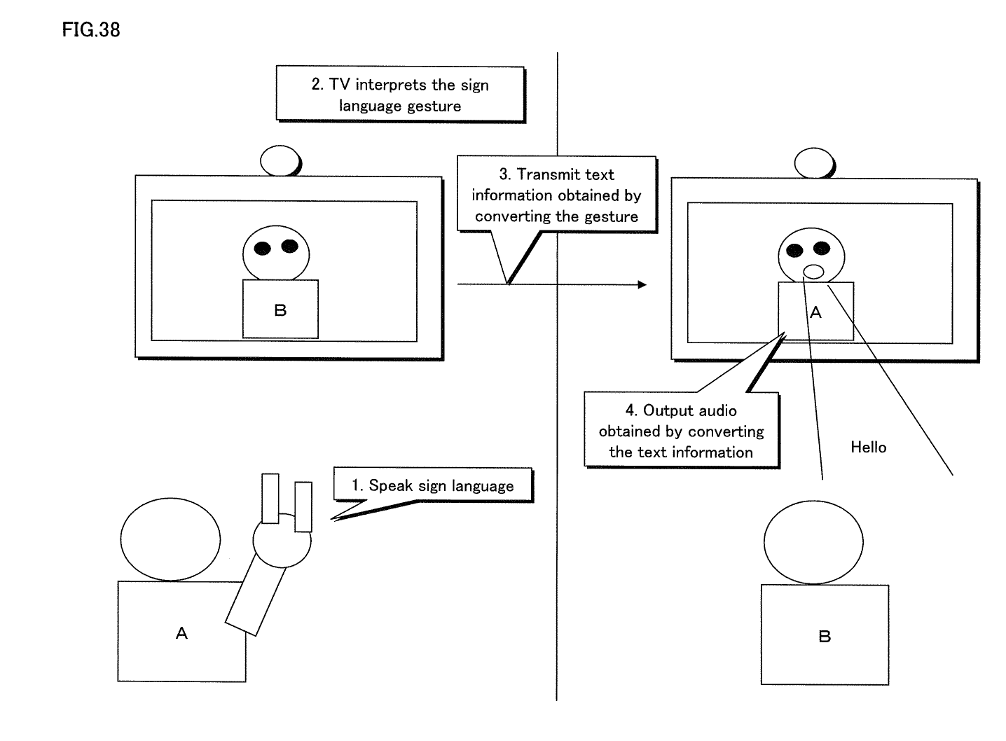

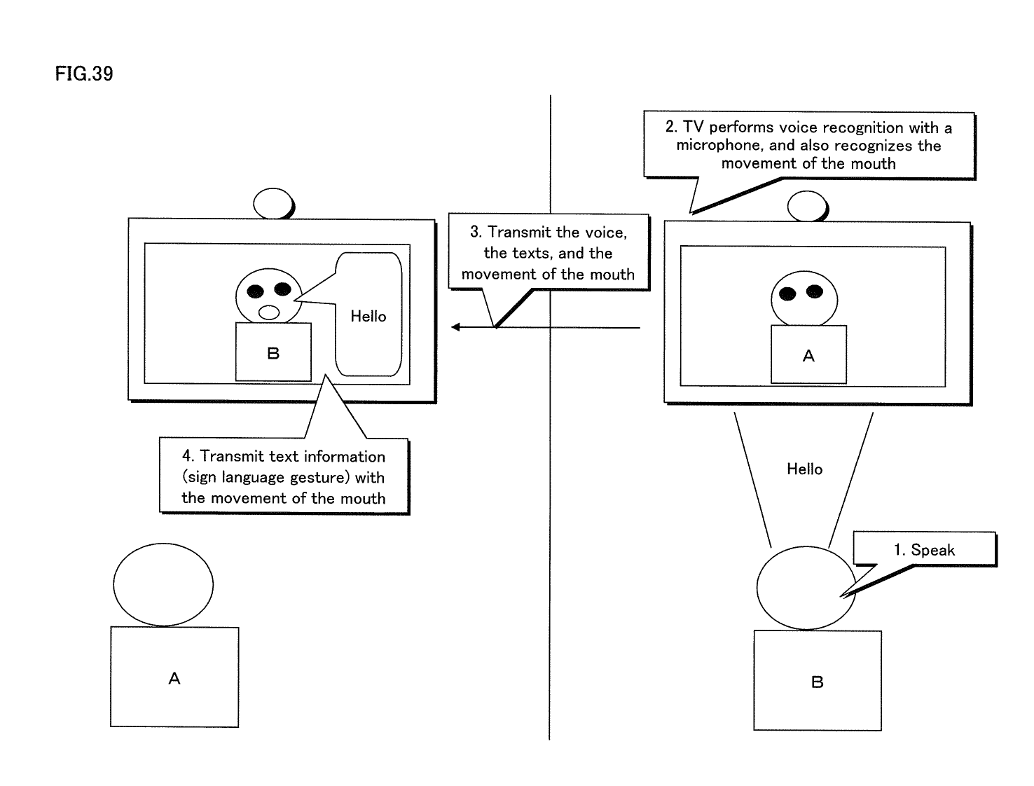

A problem in communications between a hard-of-hearing person and an able-bodied person is that an able-bodied person cannot use sign language. The following explains an image generation device that can solve this problem. FIG. 38 and FIG. 39 are schematic views of the system. The user A is a hard-of-hearing person, and the user B is an able-bodied person. The TV of the user A (e.g. the display 190) shows the model of the user B, and the TV of the user B shows the model of the user A. The following explains the processing steps performed by the system. First, the processing steps by which the user A as a hard-of-hearing person transmits information are explained with reference to FIG. 38. STEP 1: The user A speaks sign language. STEP 2: The head tracking section (e.g. the head tracking section 212) of the image generation device recognizes the sign language gesture as well as the head position of the user, and interprets the gesture. STEP 3: The image generation device converts the sign language to text information, and transmits the text information to the user B via a network such as the Internet. STEP 4: Upon receipt of the information, the image generation device of the user B converts the text information to audio, and outputs the audio to the user B. Next, the processing steps by which the user B as an able-bodied person transmits information are explained with reference to FIG. 39. STEP 1: The user A as an able-bodied person speaks by voice. STEP 2: The image generation device acquires the voice via a microphone and recognizes the movement of the mouth. STEP 3: The image generation device transmits the audio, the recognized text information and the information of the movement of the mouth to the image generation device of the user A via a network such as the Internet. STEP 4: The image generation device of the user A displays the text information on the screen and reproduces the movement of the mouth by using the model. The text information may be converted to a gesture of the sign language and represent it as the movement of the model of the user A. In this way, an able-bodied person who does not know the sign language can communicate with a hard-of-hearing person in a natural manner.

<Supplemental Descriptions>

Embodiments of the image generation device pertaining to the present invention have been described above by using Embodiment 1, Modification 1, Modification 2, Modification 3 and other modifications, as examples. However, the following modifications may also be applied, and the present invention should not be limited to the image generation devices according to the embodiment and so on described above.

(1) In Embodiment 1, the image generation device 100 is an example of a device that generates a CG image in the virtual space by modeling. However, the image generation device does not necessarily generate CG image in the virtual space by modeling if the device can generate an image seen from the specified point. For example, the image generation device may generate the image by a technology for compensation among images actually photographed from multiple points (such as the free viewpoint image generation technology disclosed in Patent Literature 1).

(2) In Embodiment 1, the image generation device 100 is an example of a device that detects the right-eye position and the left-eye position of the viewer, and generates the right-eye images and the left-eye images based on the detected right-eye position and the left-eye position. However, the image generation device 100 does not necessarily detect the right-eye position and the left-eye position of the viewer and generate the right-eye images and the left-eye images, if at least the device can detect the position of the viewer and generate images based on the detected position. For example, the image generation device may be configured such that the head tracking section 212 detects the center point in the face of the viewer as the viewer's viewpoint, the coordinates converter section 222 calculates the virtual viewpoint based on the viewer's viewpoint, the viewpoint converter section 235 generates an original image seen from the virtual viewpoint, and the rasterizer section 236 generates an image from the original image.

(3) In Embodiment 1, the image generation device 100 is an example of a device that calculates the viewpoint by multiplying both the X axis component and the Y axis component of the displacement from the reference point to the viewer's viewpoint by r with reference to the reference plane. However, as another example, the image generation device 100 may calculate the viewpoint by multiplying the X axis component of the displacement from the reference point to the viewer's viewpoint by r1 (where r1 is a real number greater than 1) and multiplying the Y axis component of the displacement by r2 (where r2 is a real number greater than 1 and deferent from r1), with reference to the reference plane.

(4) In Embodiment 1, the display 190 is described as a liquid crystal display. However, the display 190 is not necessarily a liquid crystal display if it has the function of displaying images on the screen area. For example, the display 190 may be a projector that displays images by using a wall surface or the like as the screen area.

(5) In Embodiment 1, the object rendered by the image generation device 100 may or may not change its shape and position as time advances.

(6) In Embodiment 2, the image generation device 1100 is an example of a device with which the view angle J1270 (See FIG. 12) will be the same as the view angle K1260. However, the view angle J1270 is not necessarily the same as the view angle K1260 if the view angle J1270 is greater than the view angle of the screen area 604 from the virtual viewpoint J950 and the screen area 604 is within the range of the view angle J1270.

(7) The following describes further embodiments and modifications pertaining to the present invention, and their respective effects.

(a) One aspect of the present invention is an image generation device for outputting images representing a 3D object to an external display device, comprising: a detection unit configured to detect a viewpoint of a viewer looking at an image displayed by the display device; a viewpoint calculation unit configured to obtain a virtual viewpoint by multiplying a displacement of the viewer's viewpoint from a reference point by r, the reference point being located in front of a screen area of the display device and r being a real number greater than 1; a generation unit configured to acquire data for generating images representing a 3D object, and generate an image representing the 3D object seen from the virtual viewpoint by using the data; and an output unit configured to output the image generated by the generation unit to the display device.

With an image generation device pertaining to an embodiment of the present invention having the stated structure, when the viewer looking at an image moves, the displacement of the virtual viewpoint, which will be the viewpoint of the image to be generated, is r times the displacement of the viewer's viewpoint (r is a real number greater than 1). With such an image generation device, when a viewer wishes to see the object from a different angle, the viewer needs a smaller move with respect to the display screen than with a conventional device.

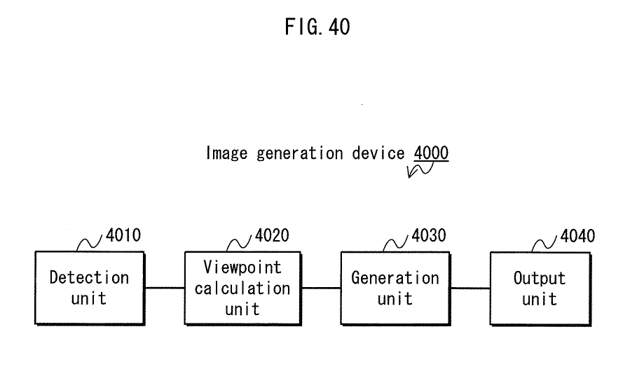

FIG. 40 is a block diagram showing a structure of an image generation device 4000 according to the modification described above.

As shown in the drawing, the image generation device 4000 includes a detection unit 4010, a viewpoint calculation unit 4020, a generation unit 4030 and an output unit 4040.

The detection unit 4010 is connected to the viewpoint calculation unit 4020 and has the function of detecting the viewpoint of a viewer looking at an image displayed by an external display device. The detection unit 4010 may be realized as the detection unit 210 (see FIG. 2), for example.

The viewpoint calculation unit 4020 is connected to the detection unit 4010 and the generation unit 4030, and has the function of obtaining a virtual viewpoint by multiplying a displacement of the viewer's viewpoint, detected by the detection unit 4010, from a reference point by r, the reference point being located in front of a screen area of the display device and r being a real number greater than 1. The viewpoint calculation unit 4020 may be realized as the viewpoint calculation unit 220, for example.

The generation unit 4030 is connected to the viewpoint calculation unit 4020 and the output unit 4040, and has the function of acquiring data for generating images representing the 3D object, and generating an image representing the 3D object seen from the virtual viewpoint obtained by the viewpoint calculation unit 4020, by using the data. The generation unit 4030 is realized as the generation unit 230, for example.

The output unit 4040 has the function of outputting the images generated by the generation unit 4030 to the external display device. The output unit 4040 is realized as the output unit 240, for example.

(b) The screen area may be planar, the reference point may be located in a reference plane and correspond in position to a center point of the screen area, the reference plane being parallel to the screen area and containing the viewer's viewpoint detected by the detection unit, and the viewpoint calculation unit may locate the virtual viewpoint within the reference plane by multiplying the displacement by r.

With the stated structure the image generation device can locate the virtual viewpoint within the plane containing the viewer's viewpoint and parallel to the screen area.

(c) The screen area may be rectangular, and the generation unit may generate the image such that, with reference to a horizontal plane containing the viewer's viewpoint, an angle of view of the image from the virtual viewpoint equals or exceeds an angle of view of the screen area from the viewer's viewpoint in a width direction of the screen area.

With the stated structure, the angle of view of the image to be generated will be equal to or greater than the angle of view of the screen area from the virtual viewpoint in the width direction of the screen area. As a result, the generated image causes less discomfort for the viewer looking at the image.

(d) The image generation device may further comprise a view angle calculation unit configured to calculate the angle of view of the screen area from the viewer's viewpoint with reference to the horizontal plane containing the viewer's viewpoint, wherein the generation unit may generate the image such that the angle of view of the image from the virtual viewpoint equals the angle of view calculated by the view angle calculation unit.

With the stated structure, the angle of view of the image to be generated will be equal to the angle of view of the screen area from the viewer's viewpoint in the width direction of the screen area. As a result, the generated image causes even less discomfort for the viewer looking at the image.

(c) The generation unit may scale down the image from the virtual viewpoint obtained by the viewpoint calculation unit such that the image matches the screen area in size.

With the stated structure, the image generation device can scale down the image so that the image can be displayed within the screen area.

(f) The generation unit may generate the image such that a center point of the image before being scaled down coincides with the center point of the screen area.

With the stated structure, the image generation device can scale down the image such that the center point of the image does not move.

(g) The generation unit may generate the image such that one side of the image before being scaled down contains one side of the screen area.

With the stated structure, the image generation device can scale down the image such that one side of the image does not move.

(h) The screen area may be rectangular, the image generation device may further comprise a view angle calculation unit configured to calculate an angle of view of the screen area from the viewer's viewpoint in a width direction of the screen area, with reference to a horizontal plane containing the viewer's viewpoint, the reference point may be located in a curved reference plane and correspond in position to a center point of the screen area, the curved reference plane consisting of points from which an angle of view of the screen area in the width direction is equal to the angle of view of the screen area calculated by the view angle calculation unit, and the viewpoint calculation unit may locate the virtual viewpoint within the curved reference plane by multiplying the displacement by r.

With the stated structure, the angle of view of the screen area from the virtual viewpoint will be equal to the angle of view of the screen areas from the viewer's viewpoint in the width direction of the screen area. As a result, the generated image causes less discomfort for the viewer looking at the image.

(i) The image generation device may further comprise a storage unit storing the data for generating the images to be output to the display device, wherein the generation unit may acquire the data from the storage unit.

With the stated structure, the image generation device can store the data used for generating the images to be output to the display device.

(j) The detection unit may detect a right-eye viewpoint and a left-eye viewpoint of the viewer, the calculation unit may obtain a virtual right-eye viewpoint by multiplying a displacement of the viewer's right-eye viewpoint detected by the detection unit with respect to the reference point by r, and obtain a virtual left-eye viewpoint by multiplying a displacement of the viewer's left-eye viewpoint detected by the detection unit with respect to the reference point by r, and the generation unit may generate right-eye images each representing the 3D object seen from the virtual right-eye viewpoint and left-eye images each representing the 3D object seen from the virtual left-eye viewpoint, and the output unit may alternately output the right-eye images and the left-eye images.

With the stated structure, the viewer, who wears 3D glasses having the function of showing right-eye images to the right eye and the left-eye images to the left eye, can enjoy 3D images that enable the viewer to feel the depth.

(k) The 3D object may be a virtual object in a virtual space, the image generation device may further comprise a coordinates converter configured to convert coordinates representing the virtual viewpoint obtained by the viewpoint calculation unit to virtual coordinates in a virtual coordinate system representing the virtual space, and the generation unit may generate the image by using the virtual coordinates.

With the stated structure, the image generation device can represent a virtual object existing in a virtual space by using the images.

### INDUSTRIAL APPLICABILITY

The present invention is broadly applicable to devices having the function of generating images.

### REFERENCE SIGNS LIST

210: Detection unit
211: Sample image storage section
212: Head tracking section
220: Viewpoint calculation unit
221: Parameter storage section
222: Coordinates converter section
230: Generation unit
231: Object data storage section
232: 3D object constructor section
233: Light source setting section
234: Shader section
235: Viewpoint converter section
236: Rasterizer section
240: Output unit
241: Left-eye frame buffer section
242: Right-eye frame buffer section
243: Selector section

1. An image generation device for outputting images representing a 3D object to an external display device, comprising:
a detection unit configured to detect a viewpoint of a viewer looking at an image displayed by the display device;
a viewpoint calculation unit configured to obtain a virtual viewpoint by multiplying a displacement of the viewer's viewpoint from a reference point by r, the reference point being located in front of a screen area of the display device and r being a real number greater than 1;
a generation unit configured to acquire data for generating images representing a 3D object, and generate an image representing the 3D object seen from the virtual viewpoint by using the data; and
an output unit configured to output the image generated by the generation unit to the display device.

2. The image generation device of claim 1, wherein
the screen area is planar,
the reference point is located in a reference plane and corresponds in position to a center point of the screen area, the reference plane being parallel to the screen area and containing the viewer's viewpoint detected by the detection unit, and
the viewpoint calculation unit locates the virtual viewpoint within the reference plane by multiplying the displacement by r.

3. The image generation device of claim 2, wherein
the screen area is rectangular, and
the generation unit generates the image such that, with reference to a horizontal plane containing the viewer's viewpoint, an angle of view of the image from the virtual viewpoint equals or exceeds an angle of view of the screen area from the viewer's viewpoint in a width direction of the screen area.

4. The image generation device of claim 3, further comprising:
a view angle calculation unit configured to calculate the angle of view of the screen area from the viewer's viewpoint with reference to the horizontal plane containing the viewer's viewpoint, wherein
the generation unit generates the image such that the angle of view of the image from the virtual viewpoint equals the angle of view calculated by the view angle calculation unit.

5. The image generation device of claim 4, wherein
the generation unit scales down the image from the virtual viewpoint obtained by the viewpoint calculation unit such that the image matches the screen area in size.

6. The image generation device of claim 5, wherein
the generation unit generates the image such that a center point of the image before being scaled down coincides with the center point of the screen area.

7. The image generation device of claim 5, wherein
the generation unit generates the image such that one side of the image before being scaled down contains one side of the screen area.

8. The image generation device of claim 1, wherein
the screen area is rectangular,
the image generation device further comprises a view angle calculation unit configured to calculate an angle of view of the screen area from the viewer's viewpoint in a width direction of the screen area, with reference to a horizontal plane containing the viewer's viewpoint,
the reference point is located in a curved reference plane and corresponds in position to a center point of the screen area, the curved reference plane consisting of points from which an angle of view of the screen area in the width direction is equal to the angle of view of the screen area calculated by the view angle calculation unit, and
the viewpoint calculation unit locates the virtual viewpoint within the curved reference plane by multiplying the displacement by r.

9. The image generation device of claim 1 further comprising
a storage unit storing the data for generating the images to be output to the display device, wherein
the generation unit acquires the data from the storage unit.

10. The image generation device of claim 1, wherein
the detection unit detects a right-eye viewpoint and a left-eye viewpoint of the viewer,
the calculation unit obtains a virtual right-eye viewpoint by multiplying a displacement of the viewer's right-eye viewpoint detected by the detection unit with respect to the reference point by r, and obtains a virtual left-eye viewpoint by multiplying a displacement of the viewer's left-eye viewpoint detected by the detection unit with respect to the reference point by r, and
the generation unit generates right-eye images each representing the 3D object seen from the virtual right-eye viewpoint and left-eye images each representing the 3D object seen from the virtual left-eye viewpoint, and
the output unit alternately outputs the right-eye images and the left-eye images.

11. The image generation device of claim 1, wherein
the 3D object is a virtual object in a virtual space,
the image generation device further comprises a coordinates converter configured to convert coordinates representing the virtual viewpoint obtained by the viewpoint calculation unit to virtual coordinates in a virtual coordinate system representing the virtual space, and
the generation unit generates the image by using the virtual coordinates.
